(19) United States
(12) Patent Application Publication
(10) Pub. No.: US 2016/0371801 A1
(43) Pub. Date: Dec. 22, 2016

(54) REAL ESTATE ANALYSIS SYSTEMS

(71) Applicant: Richard Dawson, Munster, IN (US)

(72) Inventor: Richard Dawson, Munster, IN (US)

(21) Appl. No.: 15/185,634

(22) Filed: Jun. 17, 2016

Related U.S. Application Data
(60) Provisional application No. 62/181,514, filed on Jun. 18, 2015.

(51) Int. Cl. G06Q 50/16; G06F 17/30; G06F 3/0482; G06T 11/00; G06F 3/0484; G06T 11/20

(52) U.S. Cl. CPC G06Q 50/16; G06F 3/04842; G06T 11/203; G06F 3/0482; G06T 11/001; G06F 17/30241

(57) ABSTRACT

In an example method, data pertaining to one or more parcels of land to be offered for sale is received at a database module. A computer system determines, for each parcel of land, a respective boundary line defining the parcel of land based on the received data. A graphical map is presented visually on an interactive user interface associated with the computer system. The graphical map includes a visual representation of a geographical region and at least one graphical curve overlaid on the visual representation of the geographical region. The graphical curve indicates, with respect to the geographical region, the boundary line defining a respective one of the parcels of land.

### CROSS REFERENCE TO RELATED APPLICATIONS

This application is a non-provisional of and claims priority to U.S. Provisional Patent Application No. 62/181,514, filed on Jun. 18, 2015, the entire contents of which are hereby incorporated by reference.

### TECHNICAL FIELD

This disclosure relates to systems for providing real estate-related information and analysis to users.

### BACKGROUND

A lien is a form of security interest granted over a property to secure the payment of a debt or performance of some other obligation. In some cases, if the owner of the property (often referred to as the lienee) fails to repay the debt or otherwise fulfil his obligation, an interest in the property can be transferred to the beneficiary of the lien (often referred to as the lienor). In many cases, the lienor can subsequently sell this interest to recover the delinquent obligation.

As an example, a governing authority can levy a property tax on a property within its jurisdiction (e.g., a parcel of land). If the property's owner is delinquent in paying the property tax, the governing authority can be granted a lien on the property to secure payment of the debt. If the debt remains unpaid, the governing authority can seize the property for which the property tax is owed, and sell the property (e.g., at an auction) to recover the delinquent taxes.

### SUMMARY

Implementations of a system for providing real estate-related information and analysis are described herein. Implementations of the system can provide a user with contextual information regarding one or more properties, such that the user can assess each property's value and/or desirability. As an example, a user can use the system to examine the boundaries of a property, determine the property's surroundings, ascertain the visibility and accessibility of the property, and/or obtain other contextual information regarding the property. In some cases, a user can also use the system to inspect the appearance of a property from one or more perspectives. Using this information, the user can determine if the property is suitable for his purposes.

In general, in an aspect, a method includes receiving, from a database module, data pertaining to one or more parcels of land to be offered for sale. The method also includes determining, by a computer system, for each parcel of land, a respective boundary line defining the parcel of land based on the received data. The method also includes presenting visually, on an interactive user interface associated with the computer system, a graphical map. The graphical map includes a visual representation of a geographical region and at least one graphical curve overlaid on the visual representation of the geographical region. The graphical curve indicates, with respect to the geographical region, the boundary line defining a respective one of the parcels of land.

Implementations of this aspect can include one or more of the following features.

In some implementations, the method can further include receiving, from the database module, data pertaining to a plurality of parcels of lands to be offered for sale. The method can also include receiving, on the interactive user interface, a first user input selecting a display element of the interactive user interface, and responsive to receiving the first user input, updating the graphical map to include a graphical curve representing a boundary line of a first parcel of land overlaid on the visual representation of the geographical region.

In some implementations, the method can further include receiving, on the interactive user interface, a second user input selecting the display element of the interactive user interface, and responsive to receiving the second user input, updating the graphical map to include a graphical curve representing a boundary line of a second parcel of land overlaid on the visual representation of the geographical region.

In some implementations, the method can further include receiving, via the interactive graphical user interface, an input from a user selecting a particular parcel of land from among the one or more parcels of land, and responsive to receiving the input, updating the graphical map to include a graphical curve representing a boundary line of the selected parcel of land.

In some implementations, the method can further include, responsive to receiving the input, presenting visually, on the interactive user interface, an identification number associated with the selected parcel of land.

In some implementations, the method can further include, responsive to receiving the input, presenting visually, on the interactive user interface, an assessed value of the selected parcel of land.

In some implementations, the method can further include, responsive to receiving the input, presenting visually, on the interactive user interface, information regarding a structure on the selected parcel of land.

In some implementations, the method can further include, responsive to receiving the input, presenting visually, on the interactive user interface, a tax associated with the selected parcel of land.

In some implementations, the method can further include, responsive to receiving the input, presenting visually, on the interactive user interface, one or more images of the selected parcel of land. At least one of the images can depict a visual perspective different from that of the visual representation.

In some implementations, the method can further include, responsive to receiving the input, presenting visually, on the interactive user interface, one or more parcels of land having characteristics similar to characteristics of the selected parcel of land.

In some implementations, the one or more parcels of land can be subject to a real estate auction.

In some implementations, the one or more parcels of land can be subject to a tax lien auction.

In some implementations, the data pertaining to the one or more parcels of land can be obtained from a geographical information system.

In some implementations, the data pertaining to the one or more parcels of land can include information regarding a position, a shape, an orientation, and/or dimensions of the one or more parcels of land.

In some implementations, the graphical curve can depict, on the graphical map, at least a portion of the boundary line with respect to the geographical region.

In some implementations, the graphical curve can depict, on the graphical map, substantially an entirety of the boundary line with respect to the geographical region.

In some implementations, a shape defined by the graphical curve can be substantially identical to a shape of one of the parcels of land.

In some implementations, the graphical map can include at least two graphical curve overlaid on the visual representation of the geographical region. Each graphical curve can indicate, with respect to the geographical region, the boundary line defining a respective one of the parcels of land. A first graphical curve can be presented using a first color or pattern. A second graphical curve can be presented using a second color of pattern different than the first color or pattern.

In general, in another aspect, a system includes a display device, one or more processors, and a non-transitory computer-readable medium including one or more sequences of instructions which. When the instructions are executed by the one or more processors, the instructions cause receiving, from a database module, data pertaining to one or more parcels of land to be offered for sale. The instructions also cause determining, for each parcel of land, a respective boundary line defining the parcel of land based on the received data. The instruction also cause presenting visually, on an interactive user interface displayed on the display device, a graphical map including a visual representation of a geographical region and at least one graphical curve overlaid on the visual representation of the geographical region. The graphical curve indicates, with respect to the geographical region, the boundary line defining a respective one of the parcels of land.

Implementations of this aspect can include one or more of the following features.

In some implementations, the one or more sequences of instructions, when executed by the one or more processors, further causes receiving, from the database module, data pertaining to a plurality of parcels of lands to be offered for sale, receiving, on the interactive user interface, a first user input selecting a display element of the interactive user interface, and responsive to receiving the first user input, updating the graphical map to include a graphical curve representing a boundary line of a first parcel of land overlaid on the visual representation of the geographical region.

In some implementations, the one or more sequences of instructions, when executed by the one or more processors, further causes receiving, on the interactive user interface, a second user input selecting the display element of the interactive user interface, and responsive to receiving the second user input, updating the graphical map to include a graphical curve representing a boundary line of a second parcel of land overlaid on the visual representation of the geographical region.

In some implementations, the one or more sequences of instructions, when executed by the one or more processors, further causes receiving, via the interactive graphical user interface, an input from a user selecting a particular parcel of land from among the one or more parcels of land, and responsive to receiving the input, updating the graphical map to include a graphical curve representing a boundary line of the selected parcel of land.

In some implementations, the one or more sequences of instructions, when executed by the one or more processors, further causes, responsive to receiving the input, presenting visually, on the interactive user interface, an identification number associated with the selected parcel of land.

In some implementations, the one or more parcels of land can be subject to a real estate auction.

In some implementations, the one or more parcels of land can be subject to a tax lien auction.

The details of one or more implementations are set forth in the accompanying drawings and the description below. Other features and advantages will be apparent from the description and drawings, and from the claims.

### BRIEF DESCRIPTION OF DRAWINGS

FIGS. 1A, 1B, 2A, 2B, 2C, 2D, 3A, 3B, 3C, 4, 5A, 5B, 5C, 6A, 6B, 7A, 7B, 7C, 8, 9A, 9B, 10, 11, 12, 13, 14, 15, 16 and 17 show example user interfaces of a real-estate analysis system.

FIG. 18 is a flow chart diagram of an example process for providing real estate-related information and analysis to users.

FIG. 19 is a diagram of an example computer system.

### DETAILED DESCRIPTION

This disclosure describes implementations of a system for providing real estate-related information and analysis. Implementations of the system can provide a user with contextual information regarding one or more properties (e.g., one or more parcels of land), such that the user can assess each property's value and/or desirability. As an example, a user can use the system to examine the boundaries of a property, determine the property's surroundings (e.g., the property's location relative to other properties, infrastructure, and natural formations), ascertain the visibility and accessibility of the property, and/or obtain other contextual information regarding the property. In some cases, a user can also use the system to inspect the appearance of a property from one or more perspectives (e.g., an overview view, a 45° view, a street-level angle, and/or other graphical views of a property). Using this information, the user can determine if the property is suitable for his purposes.

One of more implementations also can be used to identify properties that are available for purchase, and assist a user in identifying which of the properties that he wishes to acquire. For example, using implementations of the system, a user can view a list of properties that are available for sale, examine contextual information regarding each of the properties, and based on this information, compile a list of properties that he wishes to pursue. In some cases, the system can allow a user to review information regarding several parcels of land in rapid succession, such that the user can conduct his review more efficiently.

Implementations of the system can be used in the context of property auctions (e.g., auctions of properties seized in connection with tax delinquency lien). For example, the system can present a user with a list of properties that will be available for sale at an upcoming auction, and present the user with contextual information regarding each of the properties. Using the software tool, the user can examine each of these properties in rapid succession, identify desirable properties (e.g., properties having boundaries, surroundings, and/or other characteristics that are particularly suitable for his purposes), and compile a list of properties that he wishes to pursue during the auction. The user can refer to the system and/or the compiled list before and during the auction so that he can make informed bids.

Although use of the system is described in the context of a tax lien-related auctions, this is merely an illustrative example. Other usages of the system are also possible, depending on the implementation. For example, in some cases, the system can also include information regarding a property's topography; access to underground water, oil, gas, shale or other features; wind pattern; sun exposure; weather; or any number of other characteristics. Using this information, a user can quickly review several properties based on one or more of these characteristics, and determine if the property is suitable for harvesting natural resources, conducting advertising, farming, or other uses. In some cases, information can be presented in the form of one or more visual “layers” that are overlaid on top of a graphical map. Each layer can be switched or off to selectively display various types of information to a user.

In some implementations, each property can be identified by its assessor's parcel number (APN), a unique number assigned by a governing authority (e.g., a county tax assessor). An APN also can be referred to as folio number, a tax identification number, a personal identification number, or a parcel identifier number. In some cases, implementations of the system can identify a property based on its APN, either instead of or in addition to the mailing or street address of the property. This can be beneficial, for example, as an APN will often uniquely identify a particular property, whereas an address can sometimes correspond to several properties at once (e.g., several parcels of land encompassed by a common address). Therefore, in some cases, an address may not be specific enough to identify a single property. Further, in some cases, the postal service may not assign an address to vacant land, billboards, reservoirs, or other non-mail receiving locations. In contrast, an APN can often identify these types of properties.

Further, in some implementations, the system can display boundaries for a property (e.g., the boundaries of a parcel of land), rather than simply displaying a marker that approximates the location of a property. This can beneficial, for example, as it allows a user to inspect the precise size and shape of a property's boundaries, such that he can more accurately assess a property. Further, in some cases, the system can display other contextual information regarding the property in the form of text and/or images alongside the boundary information, such that a user can quickly review this additional information without having to cycle through several pages of information. Further still, the system can allow a user to select surrounding properties (e.g., by clicking on neighboring parcels of land on a graphical map) in order to view contextual information regarding those properties as well.

In some cases, the system also can allow a user to filter a list of properties based on one or more criteria, such that only properties having particular desired characteristics are displayed. A user can quickly navigate through this list of properties (e.g., by selecting “next” or “back” navigation options on a user interface) in order to view each of these properties in succession. Further, the system can allow the user to remove a property being viewed from the list, such that the user ends up with a list of selected properties (e.g., a “short list”) at the end of his review. This list of selected properties can be exported for future review or processing.

In many cases, a property's boundary information can be defined using a geographical information system (GIS), or a system configured to capture, store, manipulate, analyze, manage, and/or present spatial or geographical data. For example, a GIS can information spatial and/or geographical data that defines the position, shape, orientation, and/or dimensions of a property's boundary. Implementations of the software tool can retrieve property boundaries from a GIS or an associated database, such that it can render and display property boundary information to a user. In some cases, a GIS can also include additional information, such as a property's tax assessed value, current owner name and address, square footage or acreage, zoning use code, and other information. The system can display some or all of this additional information to the user.

In some implementations, property boundary information can be defined by several different GISes. Implementations of the system can retrieve information from several GISes, and present the user with aggregated information regarding several different properties. For example, in some cases, each of several county governing authorities can maintain a database of property information for the properties in its jurisdiction. Implementations of the software tool can retrieve information from several GISes, and present the user with aggregated information regarding several different properties in several different counties. Thus, a user is not limited to examiner properties from a single region, and instead can review properties from any number of regions at once.

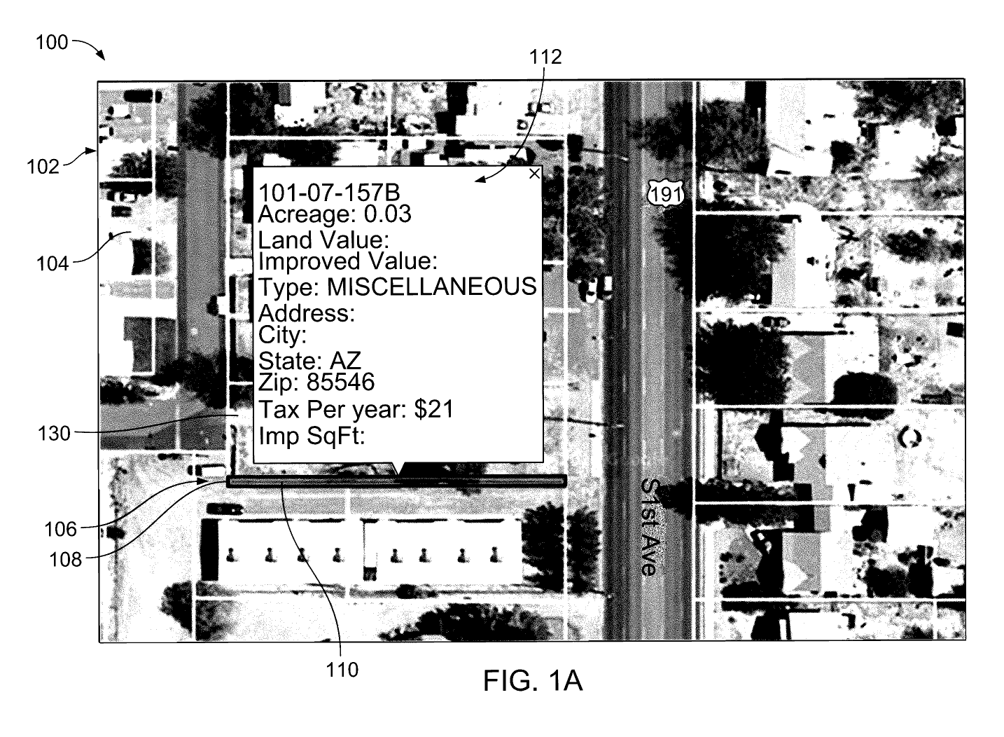

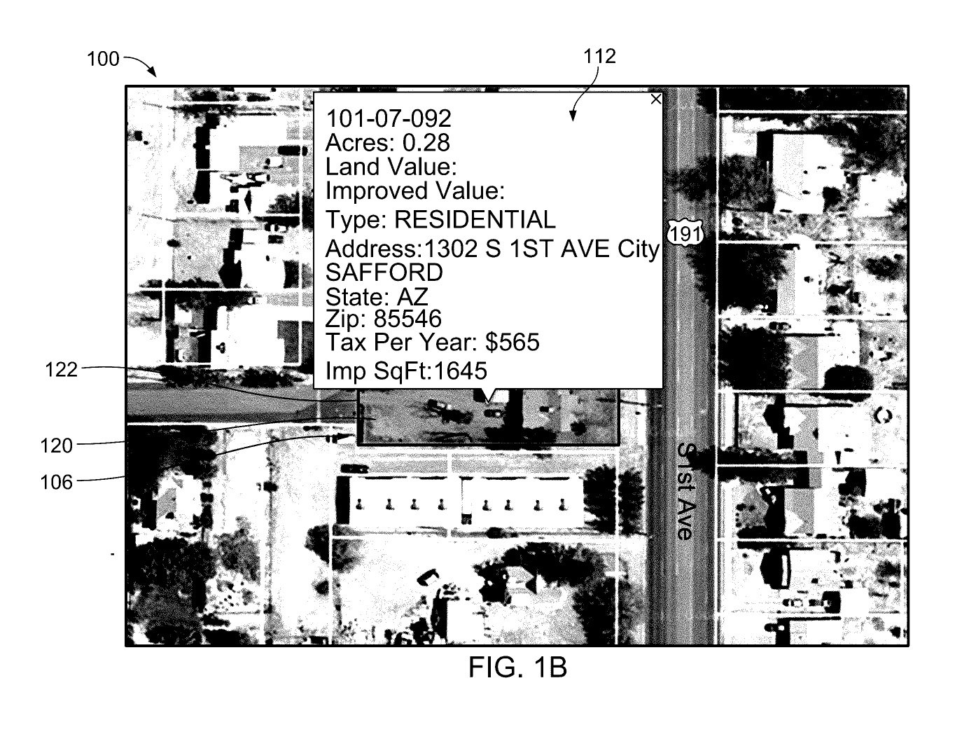

In some implementations, the system can display information using a graphical map presented on a user interface. In some cases, a graphical map can be generated based on information provided by a mapping service (e.g., Google Maps). Information about each property (e.g., boundary lines and other contextual information) can be overlaid on the map, such that a user has access to several types of information simultaneously. For example, as shown in FIG. 1A, a graphical map 100 can include a layer 102 containing images 104 of a region from an overhead perspective. The graphical map 100 can also include a boundary lines layer 106 indicating the boundaries 108 of a particular property 110. The graphical map 100 can also include a text layer 112 that includes other contextual information regarding the property, such that identification numbers, acreage, land value, improved value, type of property, address, tax information, and improvement square footage. Other combinations of information are also possible, depending on the implementation.

In some cases, a user can view information regarding other properties by selecting those properties on the graphical map (e.g., by clicking, pressing, or otherwise selecting portions of the graphical map corresponding to the desired property). In response, the graphical map updates to reflect the user's selection. For example, as shown in FIG. 1B, when a user selects a second property 120, the graphical map 100 updates the boundary lines layer 106 to indicate the boundaries 122 of the second property 120, and updates the text layer 112 to include other contextual information regarding the second property 120. In this manner, a user can intuitively select different properties in a region, and directly compare one property against another.

As described above, in some implementations, a user can filter and rapidly view lists of properties (e.g., tax-delinquent properties that will be sold at an auction in the future). In some cases, one or more lists of properties can be inputted into to the system (e.g., manually inputted by an administrator or automatically inputted based on data retrieved from a remote database). These lists of properties can be made available to users to the system for review. In some cases, a user can upload customized lists of properties (e.g., by manually inputting one or more properties or automatically inputting properties based on a data retrieved from a remote database).

In some cases, the system can be implemented, at least in part, using one or more web pages. For instance, the system include a web server module that provides users with access to one or more web pages. The user can retrieve the web pages remotely (e.g., using a client computer communicatively coupled to the web server module, such as through the internet, local area network, or other communications network) in order to review information provided by the system. The user also can interact with the web pages to input commands to the system.

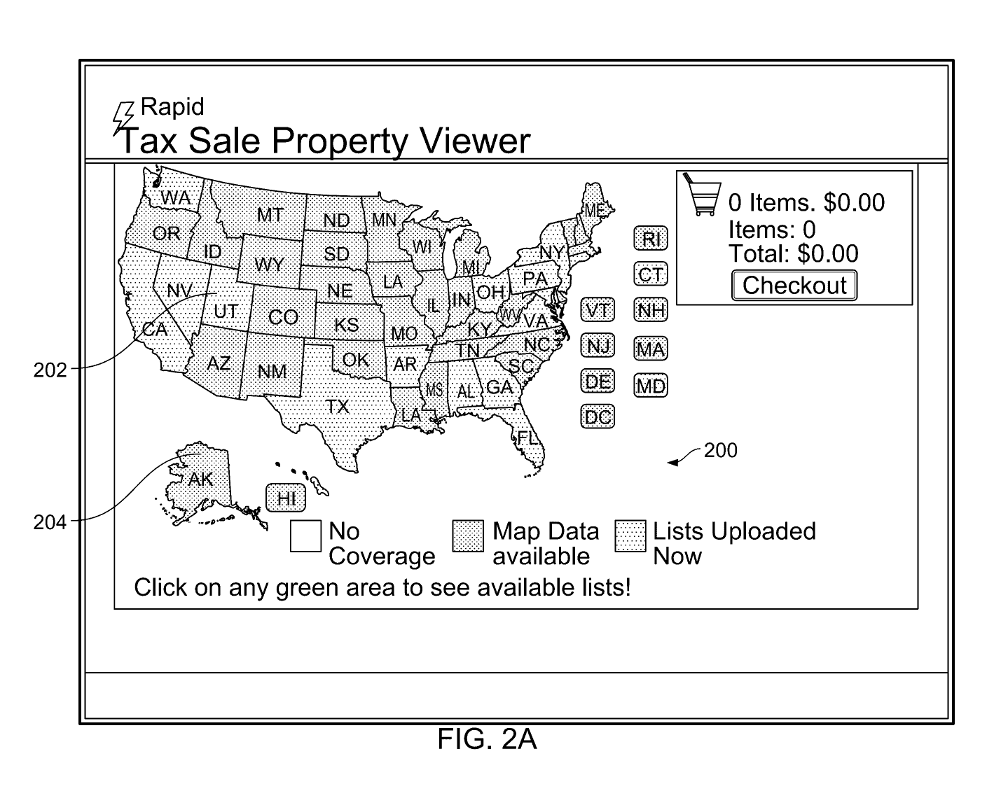

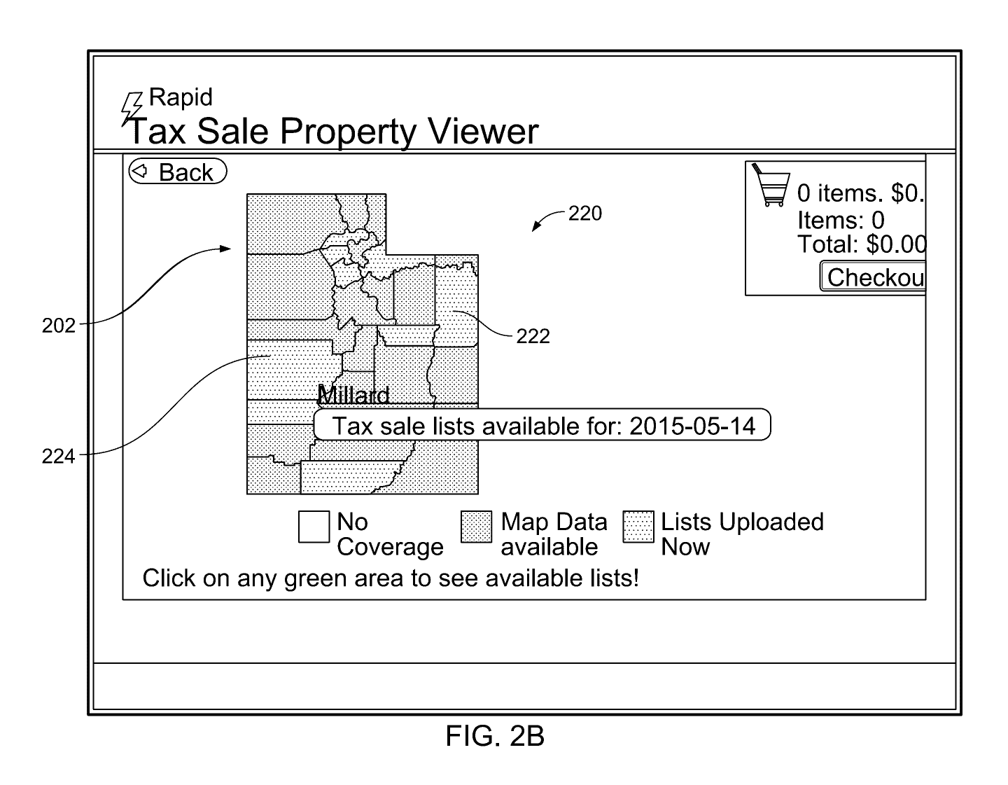

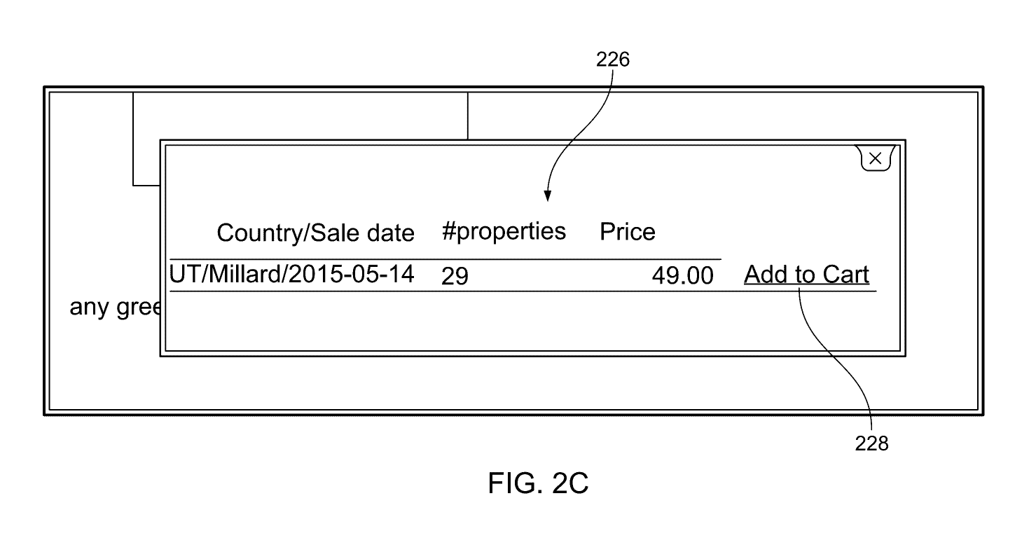

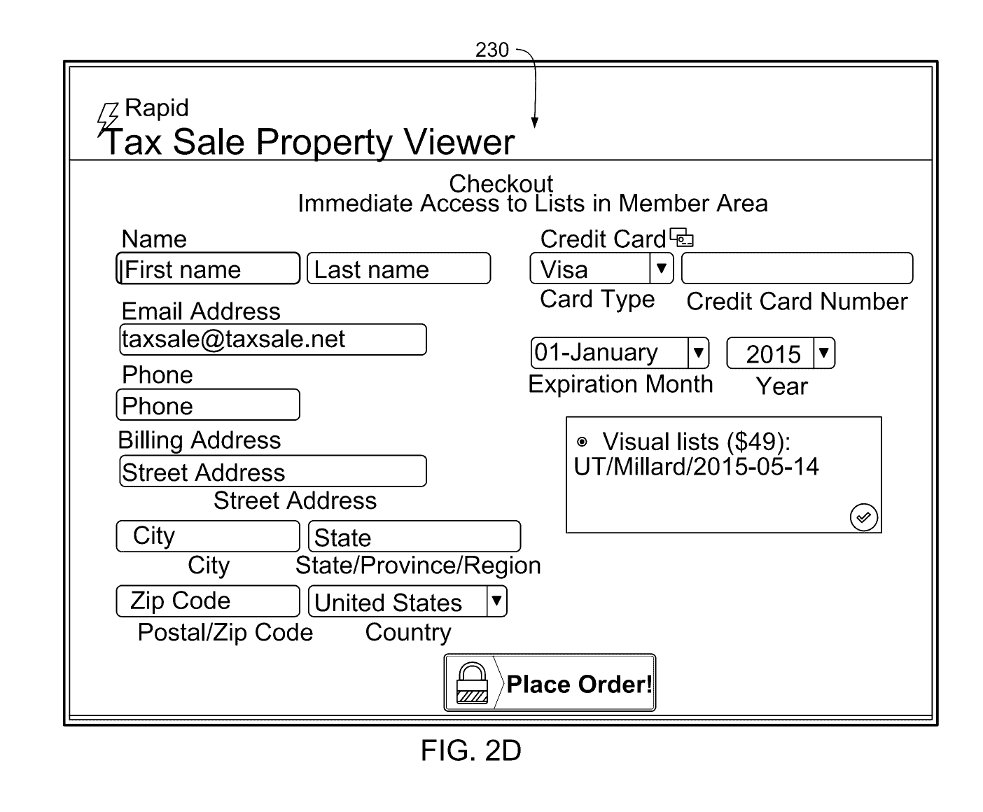

As an illustrative example, a user can access the system by navigating to a website associated with the system. The user can identify himself to the system (e.g., by entering login credentials, such as his email address and/or password). After the user is authenticated, the system displays properties and/or geographical regions for which information is available (e.g., information regarding lists of tax-delinquent properties that will be sold at an auction in the future). For example, as shown in FIG. 2A, the system can present a nationwide map 200 at a state level. In some cases, if one or more property lists are available for a particular state, the state can be shaded green (e.g., state 202), and if no lists are available in a particular state, the state can be shaded blue (e.g., state 204). Other combinations of colors are also possible, depending on the implementation.

As shown in FIG. 2B, if the user selects a state having an available property list (e.g., by clicking on a green state 202), the system displays a county-level map 220. The county-level map 220 can be displayed in a similar manner as the nationwide map 200. For example, if one or more property lists are available for a particular county, the county can be shaded green (e.g., county 222), and if no lists are available in a particular county, the county can be shaded blue (e.g., county 224). As noted above, other combinations of colors are also possible, depending on the implementation.

A user can select a particular county to purchase information regarding the selected county. For example, as shown in FIG. 2C, when the user selects a county having an available property list (e.g., by clicking on a green county 222), the system displays information 226 regarding the selected county 220 (e.g., the number of listed properties within that county), and a price 226 for purchasing information regarding the selected county 222. The user can indicate that he wishes to purchase information regarding the county 222 (e.g., by selecting an “add to cart” option 228), and complete the transaction by inputting appropriate identifying and financial information 230 (as shown in FIG. 2D).

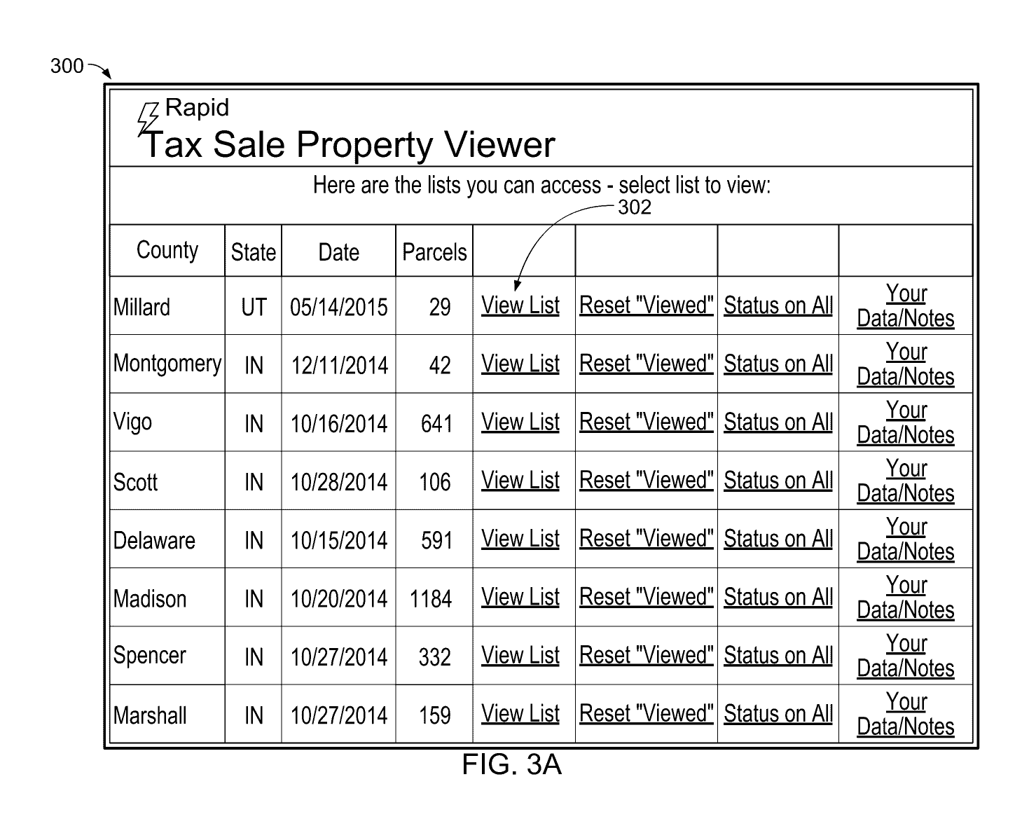

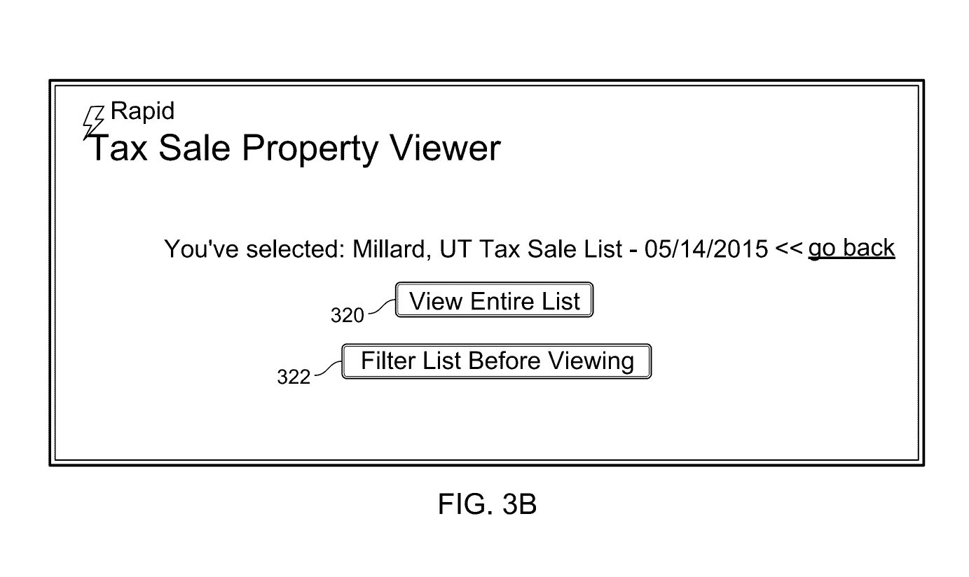

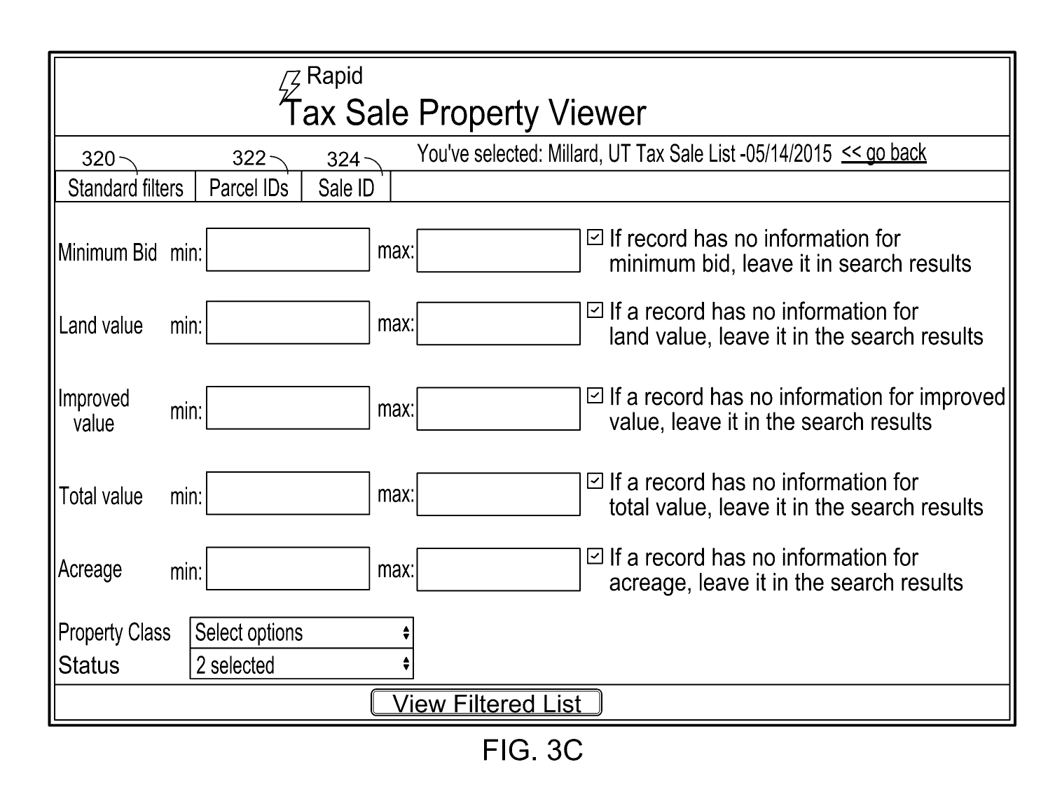

Once the transaction has been completed, the user can access the purchased information. For example, as shown in FIG. 3A, the system can display one or more lists of properties 300 that are available to the user. The user can select a list 300 (e.g., by clicking on a “view list” option” 302) in order to retrieve information from the selected list 300.

In some cases, each property can have one of several different statuses. For example, if the user has previously viewed information regarding a property, the property can have a “viewed” status. If the user has not previously viewed information regarding a property, the property can have a “not viewed” status. If the user has indicated that he is interested in the property, the property can have a “on bid list” status (e.g., indicating that the user is considering bidding on the property at auction). If the user has indicated that he is not interested in the property, the property can have a “removed” status (e.g., indicating that the user is not considering bidding on the property at auction).

The status of each property can be modified by the system based on the user's interaction with the system with respect to each property. For example, the system can automatically modify the status of a property from “not viewed” to “viewed” if a user has viewed a property. If the system receives an indication that the user is interested in the property, the system can modify the property's status to “on bid list.” If the system later receives an indication that the user is no longer interested in the property, the system can modify the property's status of “removed.” A user also can manually modify the statuses of properties. For example, a user can indicate that one or more properties have a status of “not viewed,” even if he has previously viewed those properties. This allows the user can manually control the status of the properties as needed.

In some cases, when the user selects a list, he can opt to either view all of the properties on a list, or filter the list, such that a subset of the properties matching particular criteria are displayed. As example, referring to FIG. 3B, when the user selects a list (e.g., by clicking the “view list” option), they can be presented with the option 320 to “view entire list” or the option 322 to “filter list before viewing.” If the user selects the “view entire list” option 320, the system displays a main viewing area, as described below, and loads the entire property list for viewing. If the user selects the “filter list before viewing” option 322, the system presents the user with options for filtering the property list.

The property list can be filtered based on one or more criteria. This can be beneficial, for example, as it allows the user to refine the list they are going to view, before spending time viewing it. Further, investors may have certain criteria for their purchases, and may be able to eliminate one or more properties quickly by specifying filtering criteria. For example, this can be especially useful on large lists that can number 25,000 properties or more.

As an example, a filtering interface is shown in FIG. 3C. As shown in FIG. 3C, a user can access a “filter” tab 320 in order to filter a property list according to criteria such as minimum bid, land value, improved land value, total value, acreage, and property class.

A property's minimum bid refers to the minimum bid that can be made for that property at auction. This filtering criteria can be useful, for example, as a user may not consider an investment worthwhile unless there is some minimum investment made, in which case the user would set a minimum value for the “minimum bid” (e.g., $1000.00). At the same time, the user may not want to spend a large portion of his funds on only one property, and may not want to spend more than a particular amount of money on any given parcel. So in this case, the user can set a maximum value for the “minimum bid.” (e.g., $3000.00). In this instance, only properties with a minimum bid of $1000.00 to $3000.00 will be shown. Similarly, a user can specify a property's land value, improved value, total value, and/or acreage.

In some cases, a user also can specify that he wishes to view only the properties of a particular property class (e.g., residential, vacant, industrial, agriculture, etc.). In some cases, the user also can specify that he wishes to view only the properties having a particular status (e.g., “viewed,” “not viewed,” “removed,” and “on bid list”).

As shown in FIG. 3C, a user also can access a “parcel IDs” tab 322 to filter a property list according to a list of parcel identification numbers (e.g., APNs) provided by the user. This can be beneficial, for example, as it allows users who already have a list of properties that they wish to view (e.g., a pre-filtered list of properties) to directly input that list of properties into the system (e.g., by copying and pasting a list of APNs).

As shown in FIG. 3C, a user also can access a “sale ID” tab 324 to access filter properties according to sales identification numbers provided during an auction. A sale ID can be, for example, a secondary tax sale ID that is assigned to a property for a specific auction. This can be beneficial, for example, as it allows a user to quickly access properties during a live auction.

When the user has set the desired filters, or used one of the other tabs to determine which properties will be shown, they are taken to the main viewing area. Only the subset of properties that meet the criteria set here will appear.

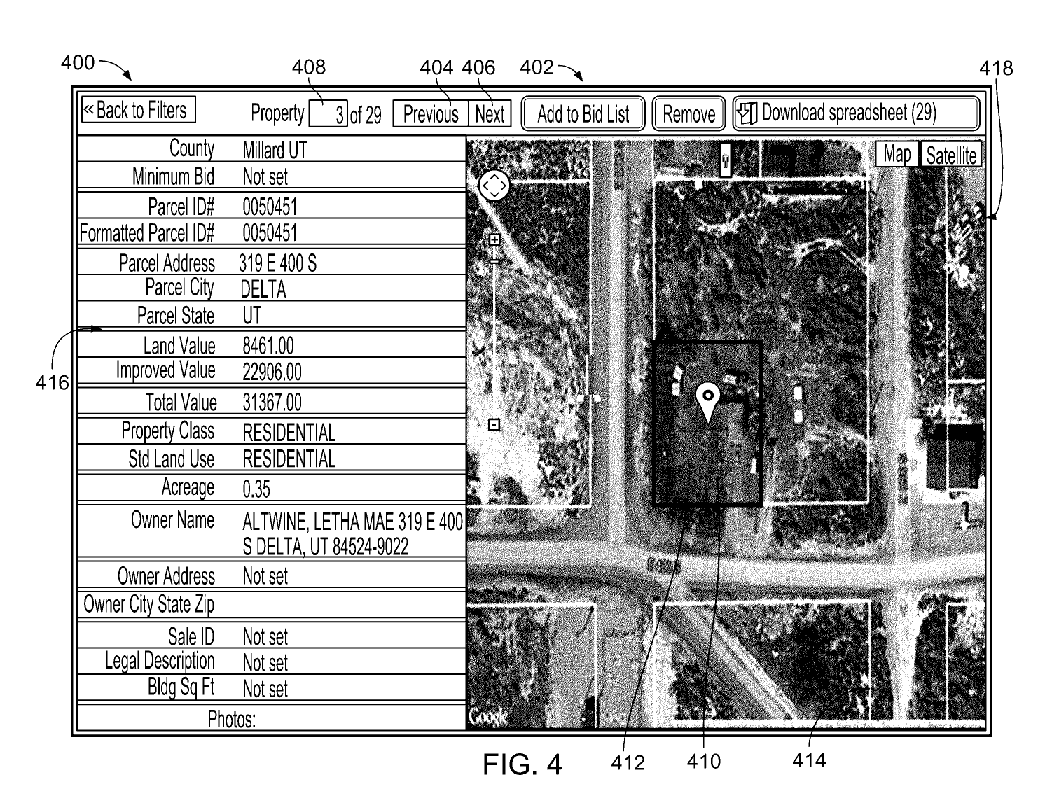

An example main viewing area 400 is shown in FIG. 4. In this example, a list of 29 properties was loaded into the viewer. A counter 402 shows where the user is on the list, in this case property 3 of 29 on the list. The Previous/Next buttons 404 and 406 are used to quickly go to the next property in the list, with no further data entry required. Also, the user can skip to any property in the list by typing manually in the input area 408 (e.g., “3” is currently displayed in this example, and “10” or “28” could be entered to skip to that number on this list)

As each property is displayed in the viewer, the subject property 410 is indicated by boundary lines 412 (e.g., outlined in blue and shaded green). Surrounding parcel lines are also indicated by boundary lines 414 (e.g., outlined in gray). Available property text information (e.g., parcel number, property class, address, assessed valuations, etc.) is shown in the grey/white text area 416 on the left. Other combinations of colors are also possible, depending on the implementation.

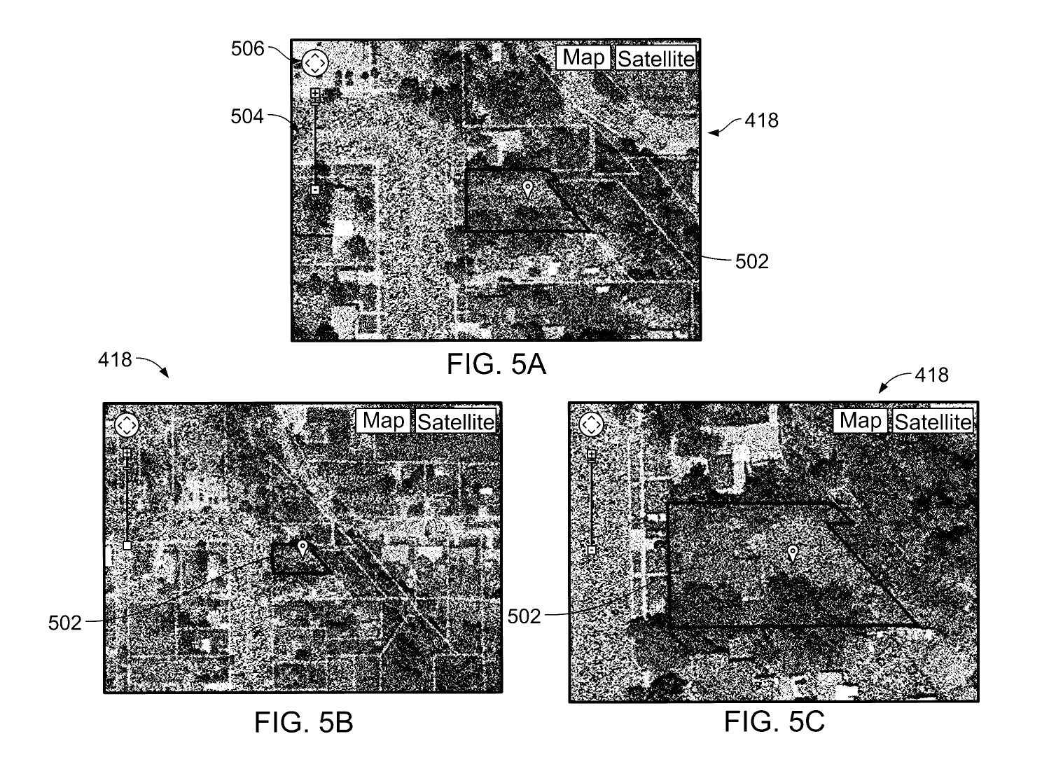

The user can interact with the graphical map 418 in order to select different geographical regions to view. For example, as shown in FIG. 5A (excerpted to show only the graphical map 418), when a property 502 is initially displayed, the graphical map 418 can be focused on the property 502 at a zoom level that is estimated to focus relatively tightly on subject parcel. A user can zoom in or out (e.g., by using mouse wheel or slider 504 on the graphical map 418). For example, as shown in FIG. 5B, a user can zoom out on the graphical map 418, such that a greater region around the property 502 is shown. As shown in FIG. 5C, a user can zoom in on the graphical map 418, such that a smaller region around the property 502 is shown. The user can also pan/navigation the map (e.g., by dragging the map or using the pan controls 506) to change the region shown.

In additional to an overhead perspective, in some cases, a user can view a property from other perspectives as well. As an example, in some implementations, a user can view a property from an angled perspective (e.g., a 45° perspective) or a street-level perspective. These perspectives can be displayed, for example, based on images provided by a third-party mapping service, such as Google Maps. This can be beneficial, as it allows a user to view a property from a variety of different angles so that he can more accurate assess a property.

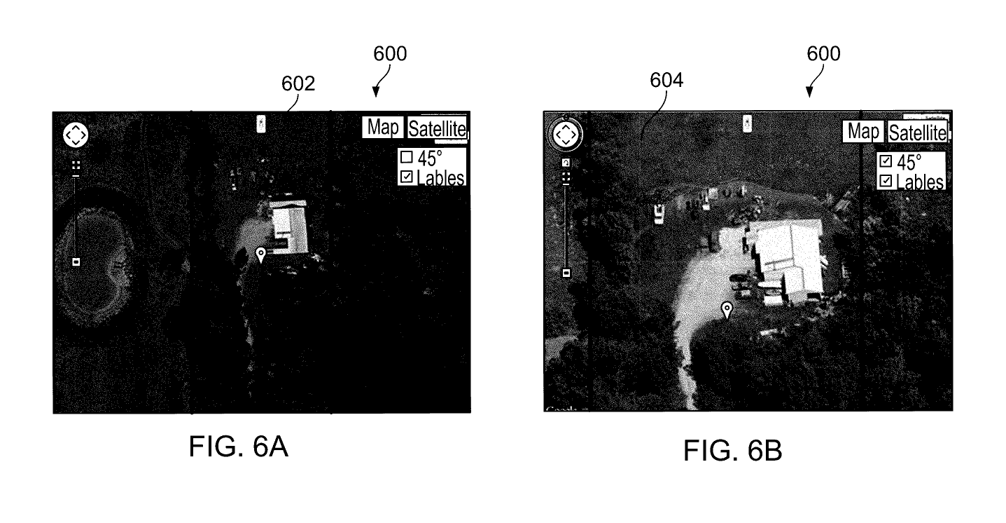

As examples, FIG. 6A shows a map 600 of a property 602 from an overhead perspective, and FIG. 6B shows the map 600 of the property 602 from an angled perspective.

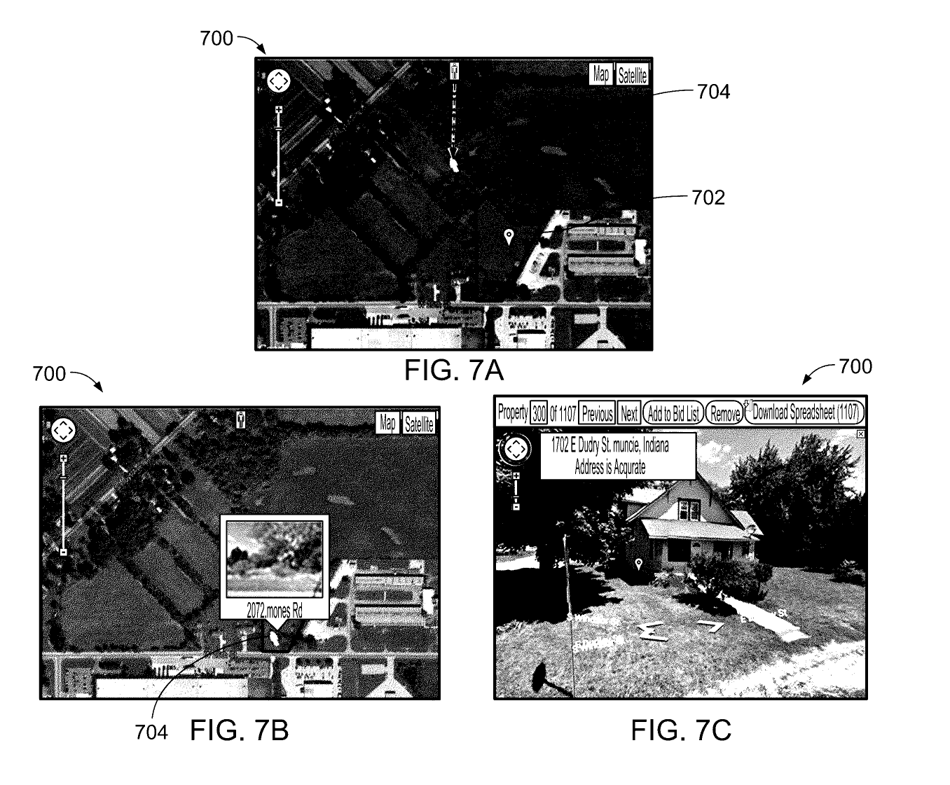

As another example, FIG. 7A shows a map 700 of a property 702 from an overhead perspective. As shown in FIG. 7A, the user can drag an indicator 704 (e.g., an icon in the shape of a person) from the top of the map 700. As shown in FIG. 7B, the user can position the icon 702 on a portion of the map 700 and release the icon 704. As shown in FIG. 7C, when the icon is released 704, the map 700 can update to show a street-level view of the selected portion of the map 700.

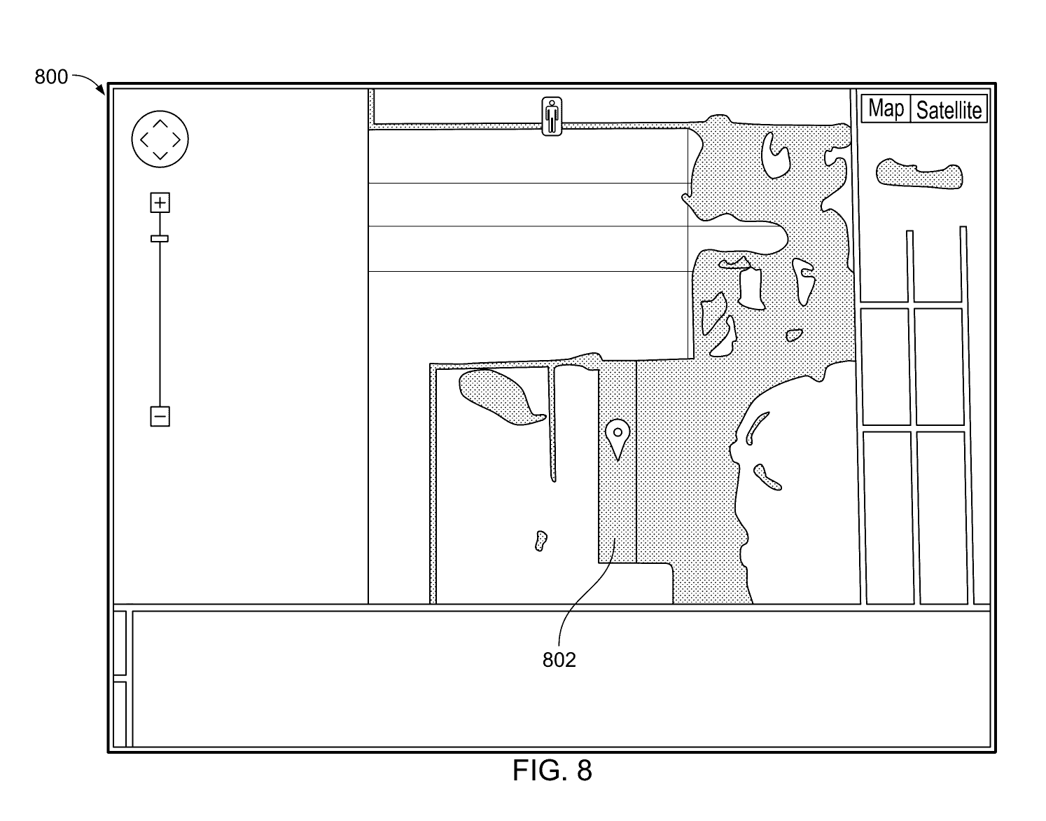

In some cases, a user can view a property from a “map” view, such that overhead images are not shown. This can be beneficial, for example, if the user wishes to view mapped features, such as roads, bodies of water, rail lines, or other features more clearly. As examples, FIG. 8 shows a map 800 of a property 802 displayed according to a “map” view.

As described above, in some cases, a property can have one of four possible statuses. For example, when a list of properties is loaded for the first time, or when the “reset status” link is clicked on the initial member area screen, all properties have a “not viewed” status.

As each property is viewed, it is automatically tagged as “viewed” by the system. This allows the user to return to the list, and in the filters screen select or deselect “viewed”.

This can be useful, for example, when a large list is being viewed by a user that could take several sessions to complete. Without this option, the user may not know where they left off on this large list, and would have to start with the entire list again and/or try to navigate to the appropriate point in the list where they left off.

In addition to the “viewed/not viewed” status which is automatically kept by the viewer, the user can manually tag a property “add to bid list” or “remove”.

If the user can see that a property is desirable and should be on their “short list” to bid on, they should click “add to bid list”. If the user can see that a property is not suitable to bid on, they should click “remove”, and if they do this, the number of properties remaining in the set will automatically decrease to reflect the property was removed.

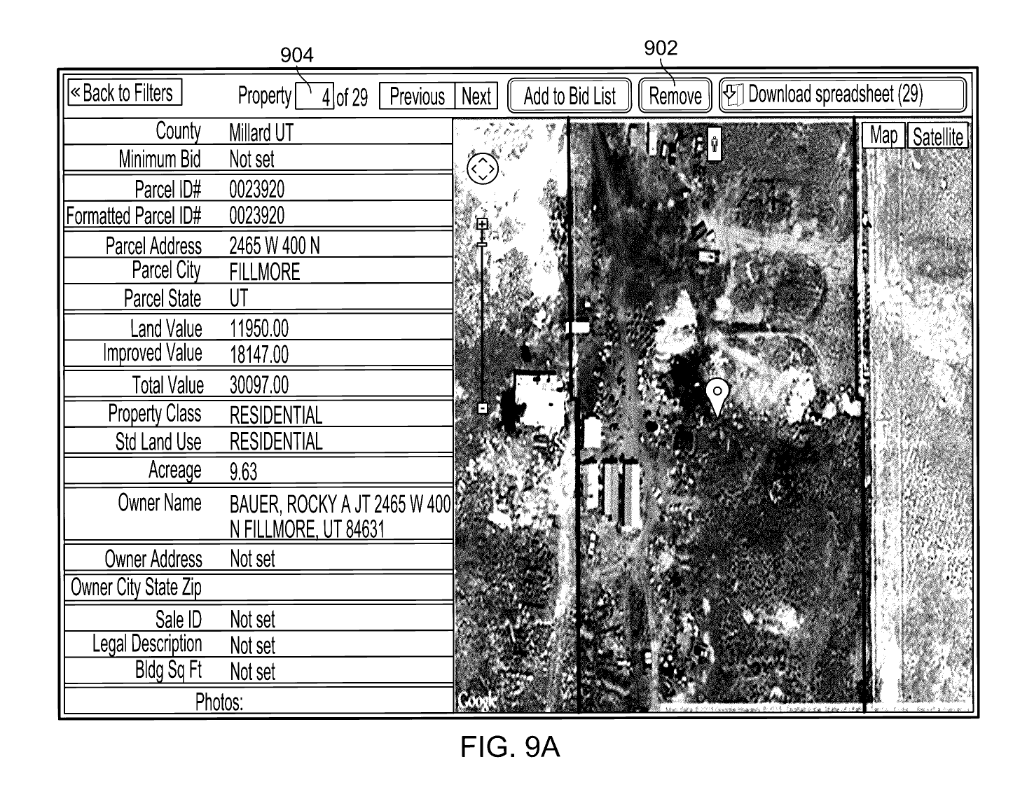

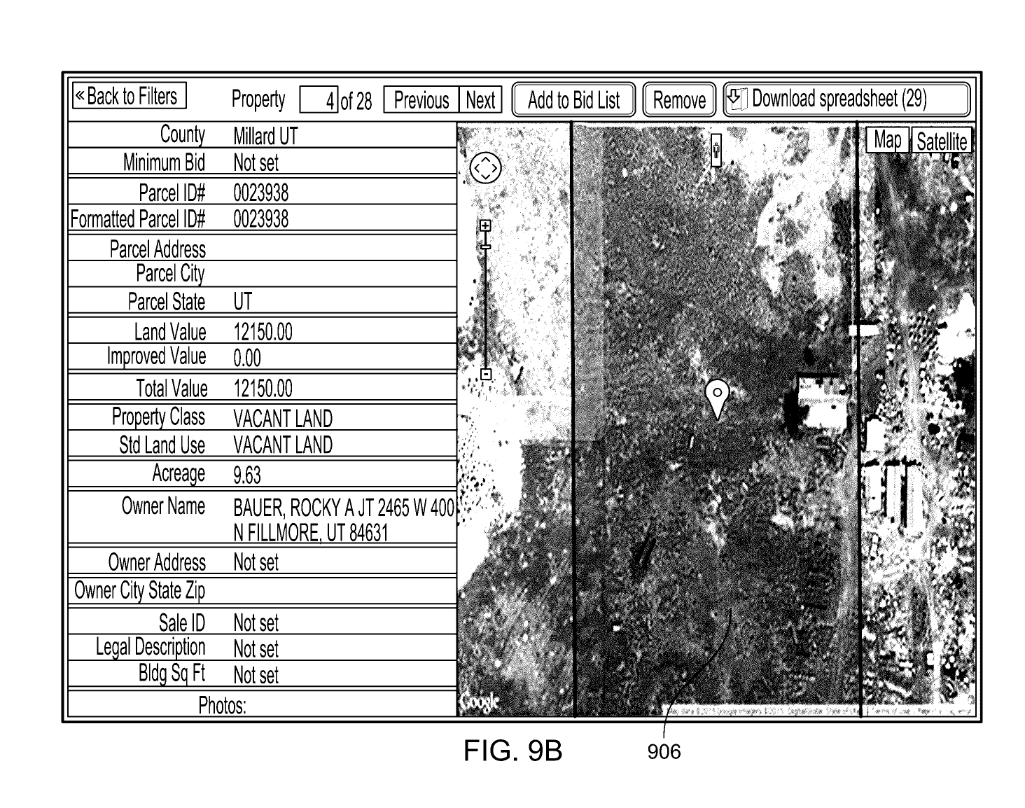

As an example, when user clicks a remove button 902 (as shown in FIG. 9A), the property count 904 changes from “29” to “28,” and the next property 906 is displayed (as shown in FIG. 9B). Thus, a user can select “remove” for properties that he is not interested in until the end of the list is reached, leaving only properties that meet both the initial criteria and his map inspection criteria.

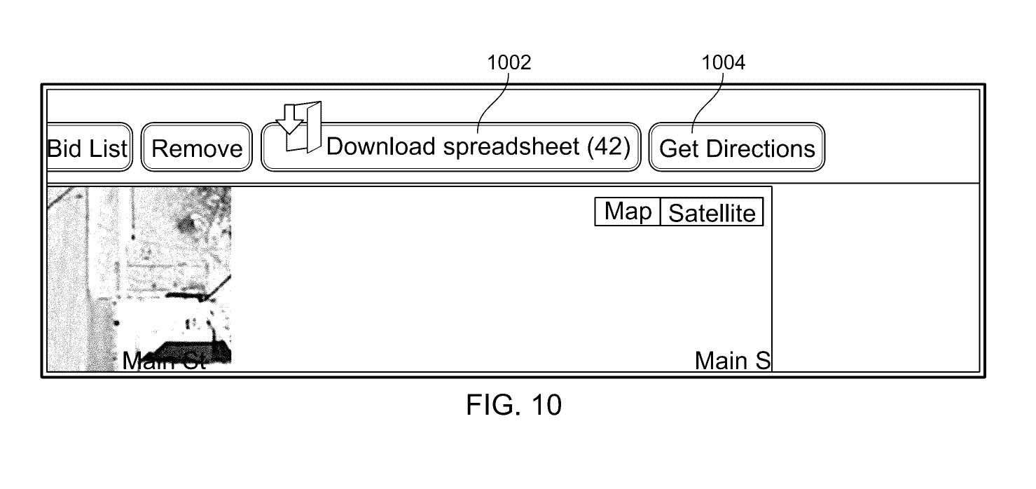

In some cases, a user can download or export data from the system. This can be useful, for example, if the user wishes to view property information in order formats (e.g., in a spreadsheet or database format), and/or share the property information with others. As shown in FIG. 10A, in some cases, a user can click on a “download” option 1002 and download a spreadsheet (e.g., a file having a .csv format) containing all property data for properties that remain in the viewer. This list can then be used, for example, for on-site inspections to confirm property suitability, and/or to take to an auction for bidding reference.

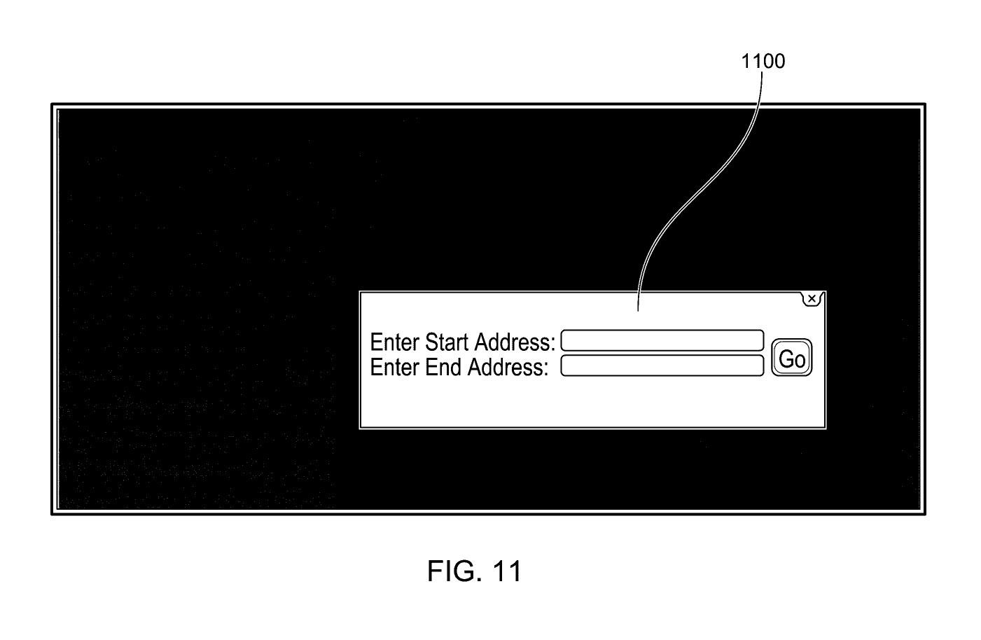

In some cases, a user can also retrieve directions to one or more properties. For example, as shown in FIG. 10, a user can select a “get directions” option 1004, and enter their starting address and ending address into an input area 1100 (as shown in FIG. 11). Based on this information, the system can display a route beginning from the starting address, passing through all the properties on the list, and finishing at the ending address, complete with driving directions. This can be useful, for example, as it allows a user to efficiently visit each of the properties on the list.

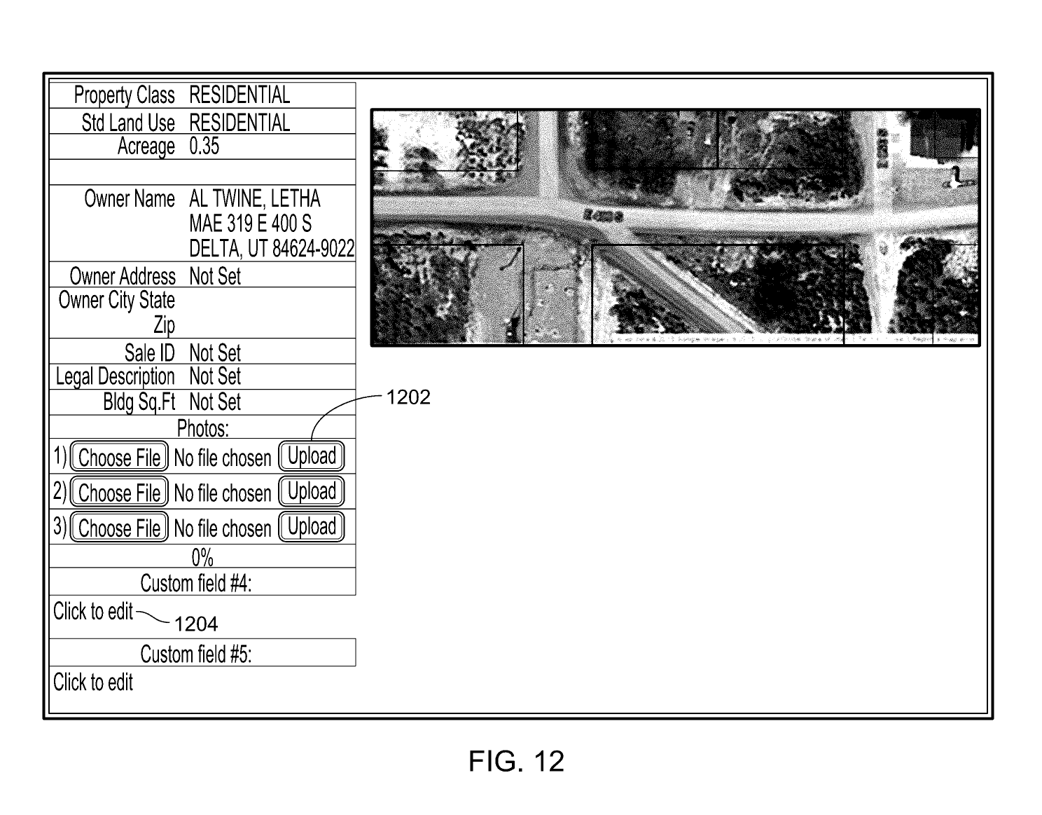

In some cases, a user may wish to input his own notes with a particular parcel. These notes can be selectively shared or hidden from with users, such that the user can control who has access to his notes. For instance, a user can upload photographs or other images (e.g., photographs taken on an in-person site inspection of a property) and/or input textual notes. In some cases, images and notes can be uploaded from a mobile device (e.g., a smartphone or tablet computer), such that a user can take their mobile device in the field, take one or more photographs, and upload those photographs and notes to the system. This information can be made available to selected other users of the system (e.g., a coworker or business partner). As an example, as shown in FIG. 12, a user can upload one or more photographs regarding a property and/or input textual notes regarding that property by selection an appropriate option on the user interface (e.g., upload commands 1202 and input areas 1204, respectively).

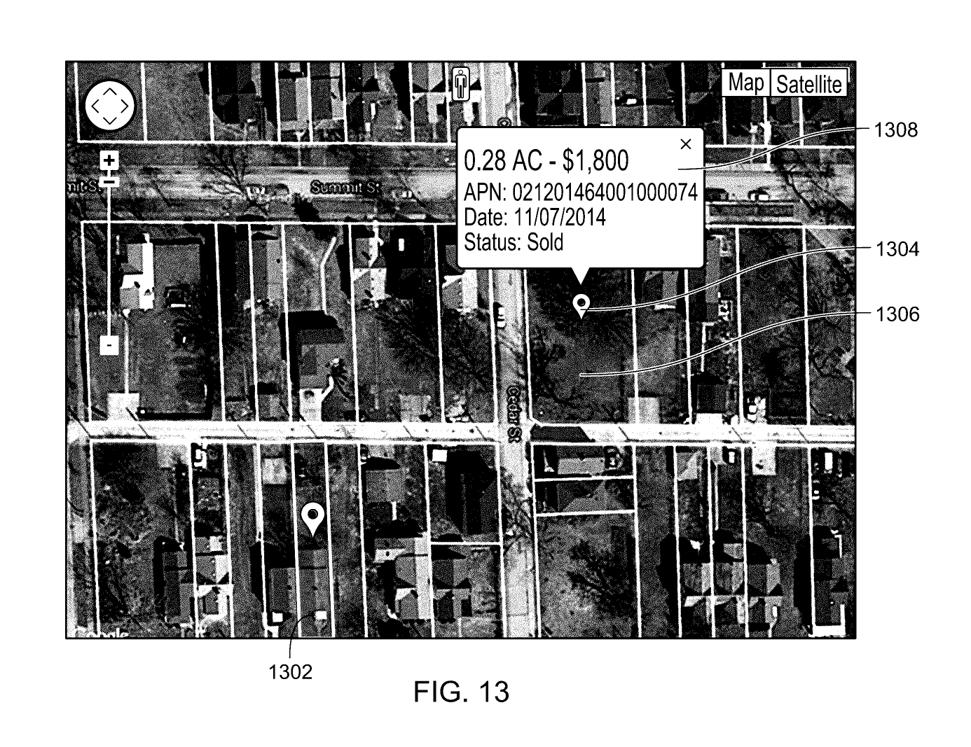

In some cases, when a property is selected, other comparable properties in the region also can be displayed. Comparable properties can include, for example, properties having similar characteristics as the selected property that were recently sold. This can be useful, for example, as it allows a user to more accurately assess the value of a selected property. For example, as shown in FIG. 13, when a user is viewing a property 1302, green markers 1304 may appear in the viewer to indicate recently sold comparable properties 1306 near the selected property. A user can select one or more of these markers 1304 to view additional information 1308 regarding the comparable properties 1306. Information regarding comparable properties can be imported into the system (e.g., manually inputted by an administrator or automatically inputted based on data retrieved from a remote database).

In some implementations, the system can be managed by an administrator. For example, in some cases, an administrator can import information into the system (e.g., information regarding property lists and comparable properties), and/or delete information from the system (e.g., outdated property lists and comparable properties). In some cases, an administrator can manage the system using an administrator interface. The administrator interface can be generally similar to the interfaces shown to a non-administrative user, can be include additional options that are available only to an administrative user.

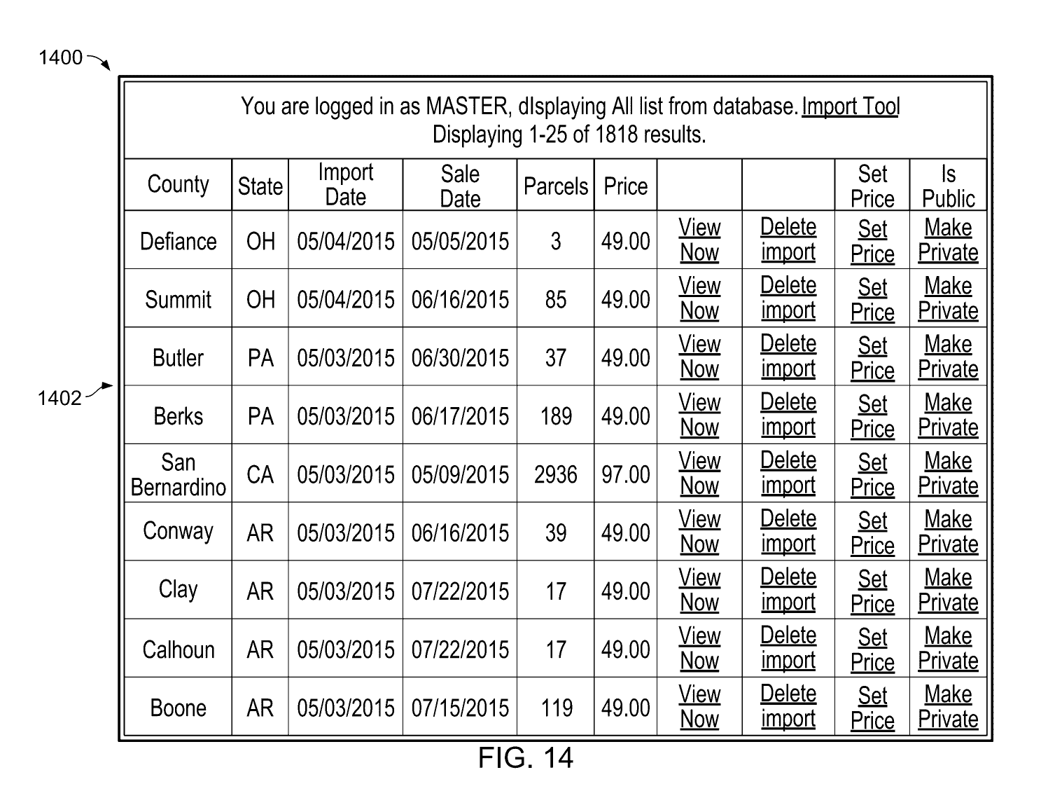

As an example, as shown in FIG. 14, an administrator interface 1400 can display all of the lists that have been uploaded to the system. An administrator interface can also include an “import” module for inputting the lists that will be offered on the user-facing site. When a new list is uploaded to the site, the map can automatically update on the user-facing site, turning the appropriate states/counties “green,” indicating that a current list is available. When a sale date passes, outdated lists can be automatically removed from the user-facing site for sale, but can be retained in the administrator interface for future review.

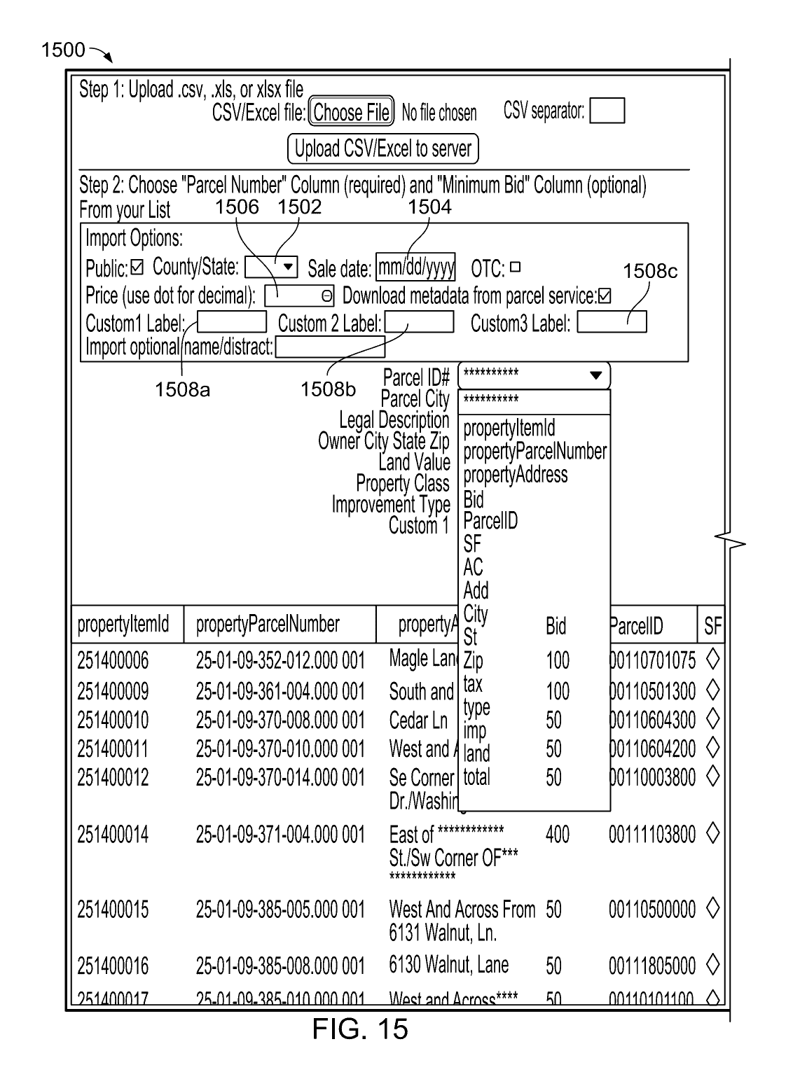

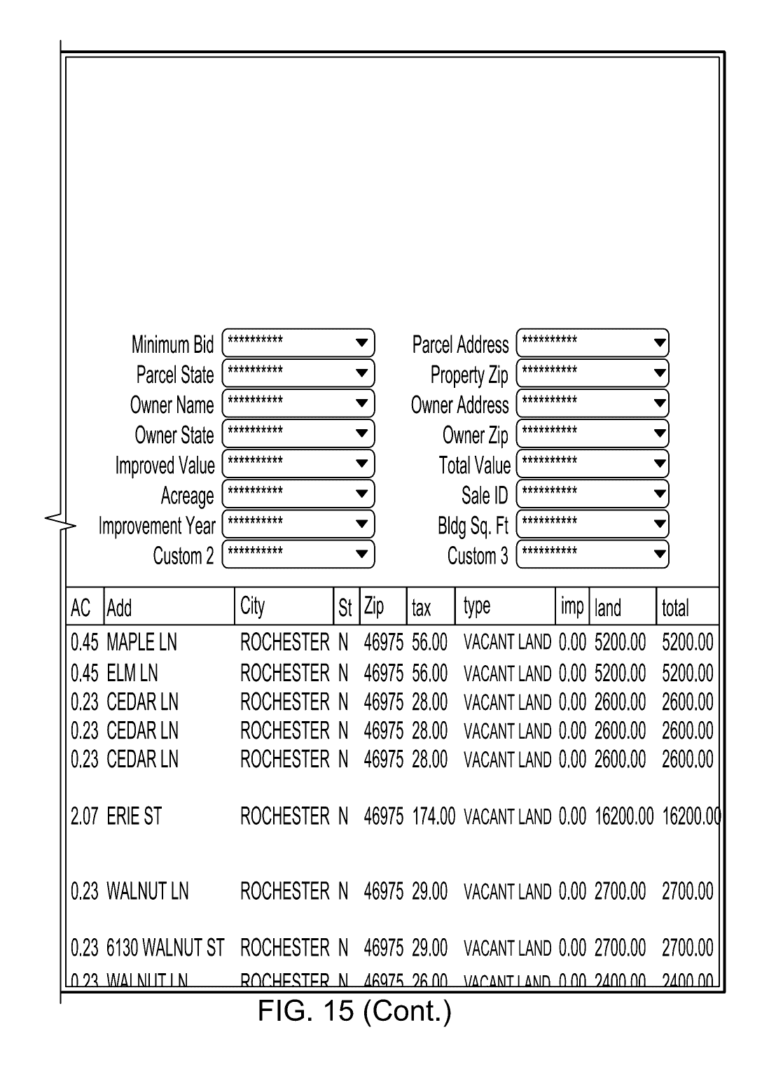

An example of an import module 1500 is shown in FIG. 15. As shown in FIG. 15, the import module 1500 can include data fields such as a field 1502 for the county/state being imported, a field 1504 for the sale date, a field 1506 for the price for list, and fields 1508a-c for custom information that may be specific to the list. This information can be imported from a spreadsheet file (e.g., a file having a .xls, xlsx, or .csv, file format, among others). As the spreadsheet is read by the import module, the administrator matches the imported data fields with the standard data fields shown in the viewer. In some cases, not all of the data fields need be imported. For example, in some implementations, a property's parcel ID may be the only required data field, but the user may wish to input additional information from a property list, for example bid amount, sale ID number, and other property data from the list. Missing property data (e.g., information not contained in the upload file or matched in this process) can be obtained from a mapping data provider when the property is viewed.

An administrator also can import information regarding comparable properties. For example, an administrator can upload information containing location information (e.g., latitude and longitude) and other property data. This information can be displayed, as appropriate, when comparable properties are displayed in the main view. In some cases, information regarding comparable properties can be maintained on an appropriate database, for example a local database or a remote database (e.g., Google Fusion Table).

In practice, the system can be implemented on one or more client computers, server computers, and/or mobile devices, depending on the implementation. In additional, one or more of the devices of the system can be local to other devices and/or remote from other devices, and communicatively coupled to those devices through an appropriate communications network (e.g., the internet, a local area network, a cellular network, or any other network).

In some implementations, the system can include, at least in part, the following modules:

1. Local MySQL database: this database can contain, for example, tax sale list information (e.g., uploaded through an administrator interface), as well as user-specific info (e.g., viewed status, lists with view permission, and user-added information/pictures).

2. API connection to parcel data provider: this API can be called in real time or near-real time when a property is viewed. As an example, a parcel number and FIPS code (a standardized 5-digit county code for the US) can be sent in a request, and the parcel layer (lines) can be returned, as well as several other property data points (latitude and longitude, address, acreage, property type, assessed values, etc.). In some cases, several data points (e.g., 500 data points or more) can be available from the provider about each property, if desired, making almost any usage possible.

3. Map API: this displays the live map, over which the “parcel line layer” is displayed.

4. Comparable Property Information: a database can be referenced, and if any comparable properties with a latitude/longitude measurement that fall within the viewer window are found, information regarding those properties can be are displayed.

An example process performed during operation of the system is described below.

1. On viewer login, an “orders” database table is queried for lists that the user has ordered.

2. Lists that have been ordered (or the user has permission to view) are then displayed on the main login screen. Each list is associated with a “list id” that is contained in the database.

3. When a user selects a list, that “list id” is referenced in the database, and all parcels associated with that “list id” are brought up. The query for these parcels is modified if the user “filters” the list or has previously viewed the list and has “viewed/not viewed/removed” statuses indicated.

4. All parcel id numbers that are brought back from this query are stored on the Main Viewer page

5. The first parcel in the list is loaded:

5a. An API call to data provider is made

5b. This returns the parcel layer and property data including the center latitude/longitude coordinates

5c. A map API instance is created, to be centered on the latitude/longitude point mentioned in step B.

5d. A database is queried to bring up any comparable properties that would be in the area

5e. The map is displayed, with the parcel layer overlaid, as well as the comparable properties that appear in the map view.

5f. The text data about the parcel is displayed in the text display area, and the parcel boundaries for the subject property (also sent back from the data provider API call) are displayed in blue.

6. Each click of the “Next” or “Previous” button repeats the steps in #5.

7. Data such as the status of the parcel (viewed/not viewed, etc) or user-entered data is written to the database in real time or near-real time when received.

Although use of the system is described in the context of a tax lien-related auctions, this is merely an illustrative example. Other usages of the system are also possible, depending on the implementation. For example, in some cases, the system can be used to evaluate mortgage foreclosure sale properties or other property “for sale” lists. Example usages are described below.

Mortgage loan package evaluation: Buyers or holders of mortgage loan packages could quickly view the current state of collateral in the portfolio. The prospective buyer can upload the list of loans contained in the package, along with the current loan balance, and be able to view each asset in the loan package. “Junk/Toxic” loan packages could be identified quickly. For example, many properties in the package may be seen to have deteriorated, burned down, become abandoned in the years since the loan was originated. As another example, current comparable properties for the area may be seen to be consistently lower than the loan balance, or outside parameters for Loan to Value range. This could arise due to property deterioration, market value decline since the loan was originated, or an inflated appraisal. If properties in the package appear to meet guidelines, only then might expensive due diligence continue.

Foreclosure action evaluation: In some cases, mortgage companies can foreclose on several properties (e.g., hundreds or even thousands of properties) each month. Often a decision must be made whether the action to foreclose will bring a net return on the property. For example, in many low-value areas, the cost to foreclose, secure the property, and remarket the property (e.g., in excess of $10,000) may exceed the net amount received for the property when sold. As another example, if the property has burned down or been demolished by the city, the property may result in a net loss and foreclosure should, in many cases, be avoided. As another example, if obvious contamination of the property (e.g., hundreds of tires visible) is observed, the liability of owning the property may be great and the lender may decide not to foreclose and own the property.

In some cases, implementations of the system can be used to view list of properties by an identification number (e.g., APN) quickly, and for almost any purpose. This can include other uses for the system by different industries, both for risk evaluation and for opportunity evaluation. For example:

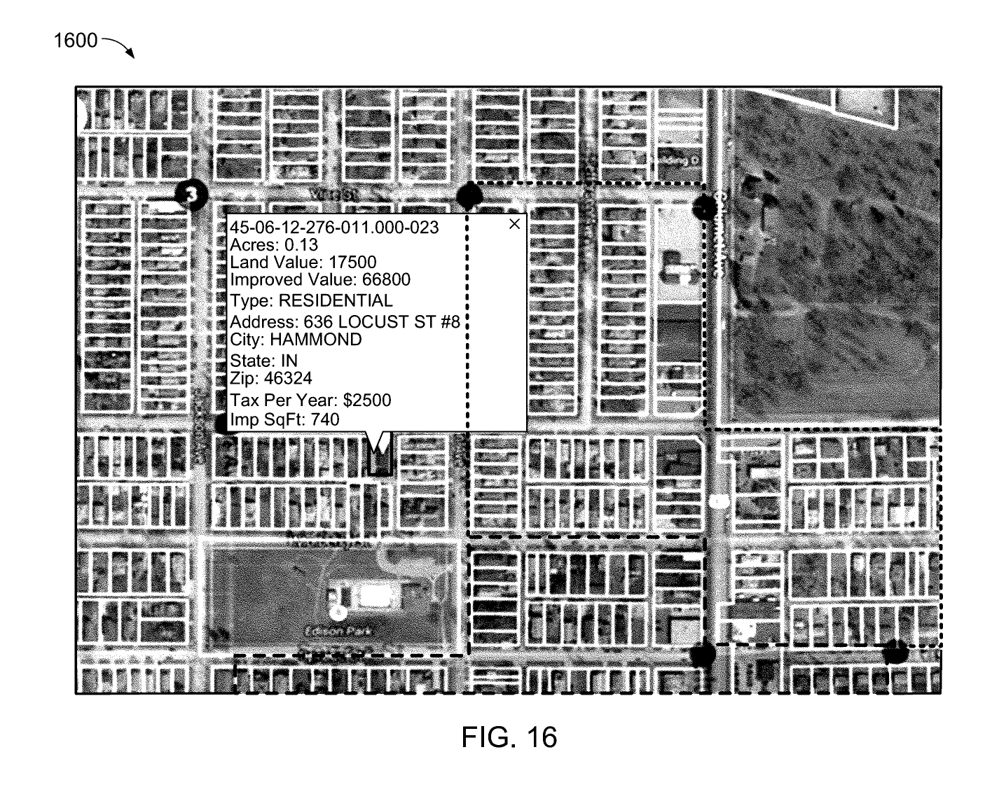

Crime Evaluation: an existing pool of properties being insured could be viewed. Deterioration in conditions could be noted resulting in a flag to investigate further. Also, using a “crime layer”, which could be overlaid the map, high-crime areas could be identified and insuring the property could be re-evaluated or discontinued. Or any evaluation of property where crime is a concern could be accomplished. An example crime layer overlay 1602 is shown in FIG. 16. The crime layer overlay 1602 is color coded to indicate crime rate. For example, green can indicate a relatively low crime rate, orange can indicate a relatively moderate crime rate, and red can indicate a relatively high crime rate. This allows the user to visually ascertain the crime rate around a particular property, and quickly identify desirable or undesirable properties.

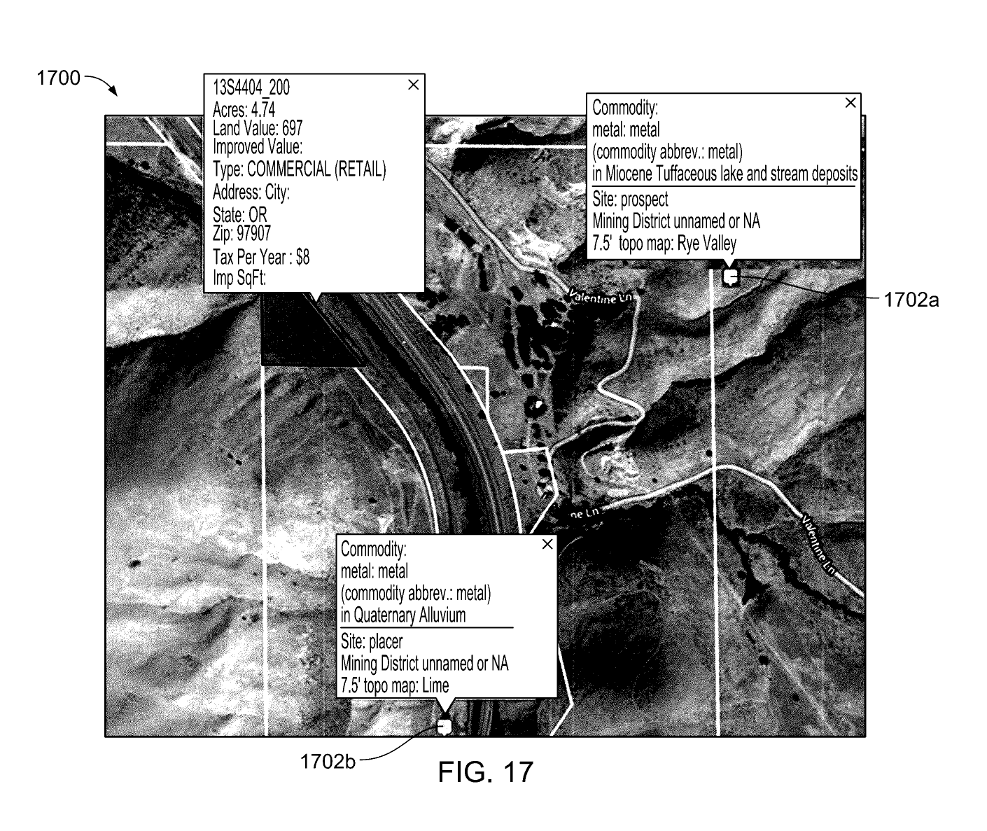

Minerals Evaluation: mineral overlays are available that show either nearby mineral operations, or likelihood of finding certain minerals in an area. Implementations of the system can be used to identify properties in these areas to buy or lease. An example mineral overlay 1700 is shown in FIG. 17. In this example, deposits of minerals are shown by markers 1702a and 1702b. This allows the user to visually ascertain whether mineral have been found in the area the past, the proximity of those minerals to a particular piece of property, and gauge the likelihood that minerals may be found on that property in the future.

Land Development prospecting: an overhead view of a prospective area can be shown, and a user can quickly select suitable development parcels and obtain owner and other property information.

Rental Portfolio/Acquisition prospecting: a user can examiner properties sold, crime, proximity to shopping, highways, public transportation, noxious uses to evaluate the desirability of an area for investing in rental properties. The user can also retrieve contact information for owners that they wish to contact directly about selling.

Mortgage Underwriting: a user can input a parcel number and look at street views, property views and area comparable sales while conducting due diligence of a lender in the mortgage underwriting process. This could be used to detect fraudulent appraisals, to avoid run-down neighborhoods or simply as a final due diligence check to look if the appraisal and deal seem to make sense.

Wind Farm/Solar Array Locating: a user can examiner a topography, sun and wind map overlay through the system and then be able to select and obtain ownership information and views of property that could be useful in identifying land that could be leased or bought for windmill or solar locations.

Consumer Use: a consumer (e.g., a home buyer or renter) can take a virtual tour around a property they are considering as a rental or purchase, look at crime overlay to determine if the area is safe, look at comparable sales in the area to educate them about values.

As implementations of the system can include information regarding properties from several different areas (e.g., properties in several different cities, counties, states, and so forth), a user can quickly and efficiently view information regarding properties from any of several different areas. Further, information from each of the properties is presented in a uniform manner, custom layers of information (e.g., those described above), can be readily applied with respect to a wide range of properties. Thus, a user can view a wide range of information using a consistent user interface conventions.

Although example user interfaces are described herein, these are merely illustrative examples. In practice, the user interfaces may differ in appearance and arrangement, depending on the implementation. Further, although example colors or shading patterns are described herein, these are also merely illustrative examples. In practice, different colors, shading patterns, and/or combinations thereof may be used to indicate information, depending on the implementation.

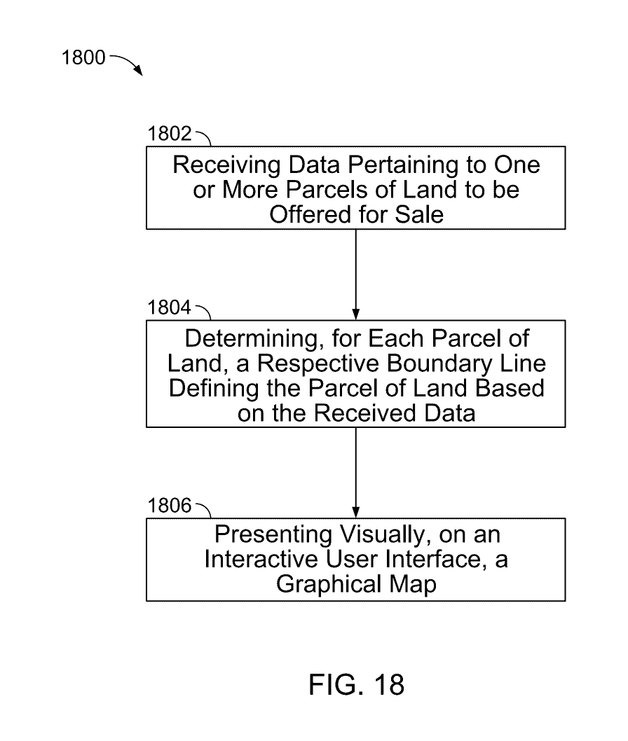

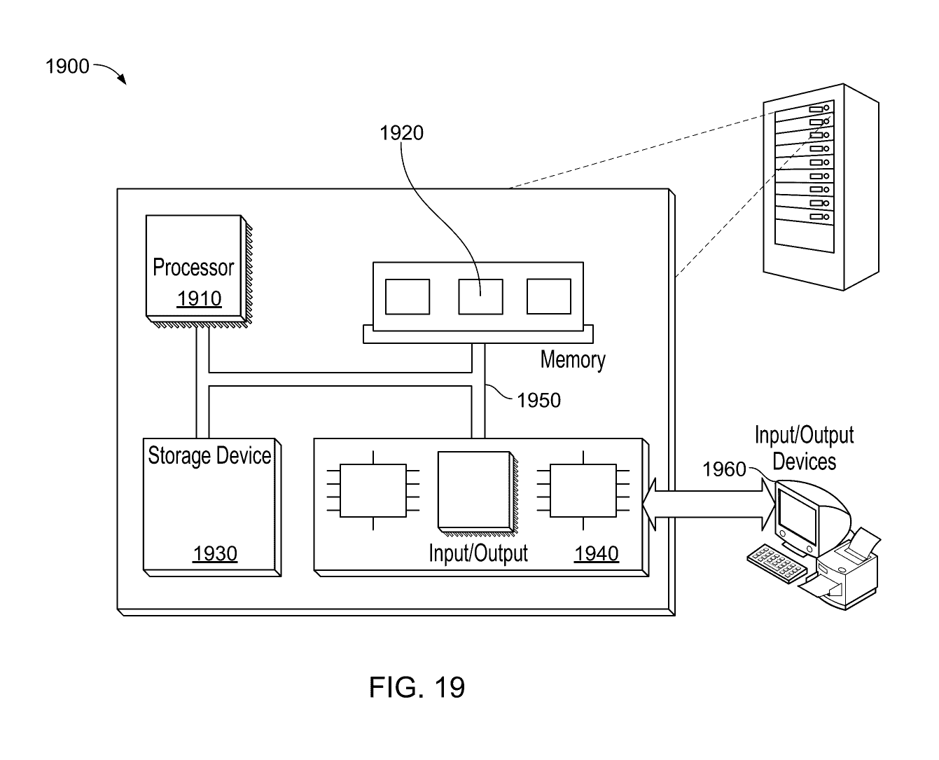

An example process 1800 for providing real estate-related information and analysis to a user is shown in FIG. 18. The process 1800 can be implemented, for example, using one or more computer systems (e.g., one or more computer systems 1900 shown in FIG. 19).

In the process 1800, data pertaining to one or more parcels of land to be offered for sale is received from a database module (step 1802). As an example, the one or more parcels of land can be subject to a real estate auction or a tax lien auction. The data can be obtained from a geographical information system, and can include information regarding a position, a shape, an orientation, and/or dimensions of the one or more parcels of land.

A computer system determines, for each parcel of land, a respective boundary line defining the parcel of land based on the received data (step 1804).

An interactive user interface is visually presented to the user (step 1806). The user interface includes a graphical map including a visual representation of a geographical region and at least one graphical curve overlaid on the visual representation of the geographical region. The graphical curve indicates, with respect to the geographical region, the boundary line defining a respective one of the parcels of land. In some cases, the graphical curve can depict, on the graphical map, at least a portion of the boundary line with respect to the geographical region. In some cases, the graphical curve can depict, on the graphical map, substantially an entirety of the boundary line with respect to the geographical region. A shape defined by the graphical curve can be substantially identical to a shape of one of the parcels of land.

In some cases, the graphical map can include at least two graphical curve overlaid on the visual representation of the geographical region, each graphical curve indicating, with respect to the geographical region, the boundary line defining a respective one of the parcels of land. A first graphical curve can be presented using a first color or pattern, and a second graphical curve can be presented using a second color of pattern different than the first color or pattern.

In some implementations, data pertaining to a plurality of parcels of lands to be offered for sale is received from the database module. A first user input selecting a display element of the interactive user interface is received on the interactive user interface. In response to receiving the first user input, the graphical map is updated to include a graphical curve representing a boundary line of a first parcel of land overlaid on the visual representation of the geographical region.

In some implementations, a second user input selecting the display element of the interactive user interface is received on the interactive user interface. In response to receiving the second user input, the graphical map is updated to include a graphical curve representing a boundary line of a second parcel of land overlaid on the visual representation of the geographical region.

In some implementations, an input is received from a user, via the interactive graphical user interface, selecting a particular parcel of land from among the one or more parcels of land. In response to receiving the input, the graphical map is updated to include a graphical curve representing a boundary line of the selected parcel of land.

In some implementations, in response to receiving the input an identification number associated with the selected parcel of land is presented visually on the interactive user interface.

In some implementations, in response to receiving the input, an assessed value of the selected parcel of land is presented visually on the interactive user interface.

In some implementations, in response to receiving the input, information regarding a structure on the selected parcel of land is presented visually on the interactive user interface,

In some implementations, in response to receiving the input, a tax associated with the selected parcel of land is presented visually on the interactive user interface,

In some implementations, in response to receiving the input, one or more images of the selected parcel of land are presented visually on the interactive user interface. At least one of the images can depict a visual perspective different from that of the visual representation.

In some implementations, in response to receiving the input, one or more parcels of land having characteristics similar to characteristics of the selected parcel of land are presented visually on the interactive user interface.

Some implementations of subject matter and operations described in this specification can be implemented in digital electronic circuitry, or in computer software, firmware, or hardware, including the structures disclosed in this specification and their structural equivalents, or in combinations of one or more of them. Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

FIG. 19 shows an example computer system 1900 that includes a processor 1910, a memory 1920, a storage device 1930 and an input/output device 1940. Each of the components 1910, 1920, 1930 and 1940 can be interconnected, for example, by a system bus 1950. The processor 1910 is capable of processing instructions for execution within the system 1900. In some implementations, the processor 1910 is a single-threaded processor, a multi-threaded processor, or another type of processor. The processor 1910 is capable of processing instructions stored in the memory 1920 or on the storage device 1930. The memory 1920 and the storage device 1930 can store information within the system 1900.

The input/output device 1940 provides input/output operations for the system 1900. In some implementations, the input/output device 1940 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. In some implementations, the input/output device can include driver devices configured to receive input data and send output data to other input/output devices, e.g., keyboard, printer and display devices 1960. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of implementations have been described. Nevertheless, it will be understood that various modifications may be made without departing from the spirit and scope of the disclosure.

What is claimed is:

1. A method comprising:
receiving, from a database module, data pertaining to one or more parcels of land to be offered for sale;
determining, by a computer system, for each parcel of land, a respective boundary line defining the parcel of land based on the received data; and
presenting visually, on an interactive user interface associated with the computer system, a graphical map comprising a visual representation of a geographical region and at least one graphical curve overlaid on the visual representation of the geographical region, the graphical curve indicating, with respect to the geographical region, the boundary line defining a respective one of the parcels of land.

2. The method of claim 1, further comprising:
receiving, from the database module, data pertaining to a plurality of parcels of lands to be offered for sale;
receiving, on the interactive user interface, a first user input selecting a display element of the interactive user interface; and
responsive to receiving the first user input, updating the graphical map to include a graphical curve representing a boundary line of a first parcel of land overlaid on the visual representation of the geographical region.

3. The method of claim 2, further comprising:
receiving, on the interactive user interface, a second user input selecting the display element of the interactive user interface; and
responsive to receiving the second user input, updating the graphical map to include a graphical curve representing a boundary line of a second parcel of land overlaid on the visual representation of the geographical region.

4. The method of claim 1, further comprising:
receiving, via the interactive graphical user interface, an input from a user selecting a particular parcel of land from among the one or more parcels of land; and
responsive to receiving the input, updating the graphical map to include a graphical curve representing a boundary line of the selected parcel of land.

5. The method of claim 4, further comprising:
responsive to receiving the input, presenting visually, on the interactive user interface, an identification number associated with the selected parcel of land.

6. The method of claim 4, further comprising:
responsive to receiving the input, presenting visually, on the interactive user interface, an assessed value of the selected parcel of land.

7. The method of claim 4, further comprising:
responsive to receiving the input, presenting visually, on the interactive user interface, information regarding a structure on the selected parcel of land.

8. The method of claim 4, further comprising:
responsive to receiving the input, presenting visually, on the interactive user interface, a tax associated with the selected parcel of land.

9. The method of claim 4, further comprising:
responsive to receiving the input, presenting visually, on the interactive user interface, one or more images of the selected parcel of land, at least one of the images depicting a visual perspective different from that of the visual representation.

10. The method of claim 4, further comprising:
responsive to receiving the input, presenting visually, on the interactive user interface, one or more parcels of land having characteristics similar to characteristics of the selected parcel of land.

11. The method of claim 1, wherein the one or more parcels of land are subject to a real estate auction.

12. The method of claim 1, wherein the one or more parcels of land are subject to a tax lien auction.

13. The method of claim 1, wherein the data pertaining to the one or more parcels of land is obtained from a geographical information system.

14. The method of claim 1, wherein the data pertaining to the one or more parcels of land comprises information regarding a position, a shape, an orientation, and/or dimensions of the one or more parcels of land.

15. The method of claim 1, wherein the graphical curve depicts, on the graphical map, at least a portion of the boundary line with respect to the geographical region.

16. The method of claim 15, wherein the graphical curve depicts, on the graphical map, substantially an entirety of the boundary line with respect to the geographical region.

17. The method of claim 1, wherein a shape defined by the graphical curve is substantially identical to a shape of one of the parcels of land.

18. The method of claim 1, wherein the graphical map comprises at least two graphical curve overlaid on the visual representation of the geographical region, each graphical curve indicating, with respect to the geographical region, the boundary line defining a respective one of the parcels of land,
wherein a first graphical curve is presented using a first color or pattern, and
wherein a second graphical curve is presented using a second color of pattern different than the first color or pattern.

19. A system comprising:
a display device;
one or more processors;
a non-transitory computer-readable medium including one or more sequences of instructions which, when executed by the one or more processors, causes:
receiving, from a database module, data pertaining to one or more parcels of land to be offered for sale;
determining, for each parcel of land, a respective boundary line defining the parcel of land based on the received data; and
presenting visually, on an interactive user interface displayed on the display device, a graphical map comprising a visual representation of a geographical region and at least one graphical curve overlaid on the visual representation of the geographical region, the graphical curve indicating, with respect to the geographical region, the boundary line defining a respective one of the parcels of land.

20. The system of claim 19, wherein the one or more sequences of instructions, when executed by the one or more processors, further causes:
receiving, from the database module, data pertaining to a plurality of parcels of lands to be offered for sale;
receiving, on the interactive user interface, a first user input selecting a display element of the interactive user interface; and
responsive to receiving the first user input, updating the graphical map to include a graphical curve representing a boundary line of a first parcel of land overlaid on the visual representation of the geographical region.

21. The system of claim 20, wherein the one or more sequences of instructions, when executed by the one or more processors, further causes:
receiving, on the interactive user interface, a second user input selecting the display element of the interactive user interface; and
responsive to receiving the second user input, updating the graphical map to include a graphical curve representing a boundary line of a second parcel of land overlaid on the visual representation of the geographical region.

22. The system of claim 19, wherein the one or more sequences of instructions, when executed by the one or more processors, further causes:
receiving, via the interactive graphical user interface, an input from a user selecting a particular parcel of land from among the one or more parcels of land; and
responsive to receiving the input, updating the graphical map to include a graphical curve representing a boundary line of the selected parcel of land.

23. The system of claim 22, wherein the one or more sequences of instructions, when executed by the one or more processors, further causes:
responsive to receiving the input, presenting visually, on the interactive user interface, an identification number associated with the selected parcel of land.

24. The system of claim 19, wherein the one or more parcels of land are subject to a real estate auction.

25. The system of claim 19, wherein the one or more parcels of land are subject to a tax lien auction.
